(19) United States
(12) Patent Application Publication
(10) Pub. No.: US 2024/0426502 A1
(43) Pub. Date: Dec. 26, 2024

(54) ENERGY MANAGEMENT SYSTEM CONTROLLER AND METHOD

(71) Applicant: Edward Helbling, Northport, NY (US)

(72) Inventor: Edward Helbling, Northport, NY (US)

(21) Appl. No.: 18/790,698

(22) Filed: Jul. 31, 2024

Related U.S. Application Data
(63) Continuation-in-part of application No. 17/989,179, filed on Nov. 17, 2022.
Application No. 17/989,179 is a continuation-in-part of application No. 17/672,816, filed on Feb. 16, 2022, now abandoned.
Application No. 17/672,816 is a continuation of application No. 16/842,913, filed on Apr. 8, 2020, now Pat. No. 11,268,730.

(51) Int. Cl. F24F 11/58; F24F 11/46; F24F 11/52; F24F 11/63; F24F 110/10; G05B 15/02

(52) U.S. Cl. CPC F24F 11/58; F24F 11/46; F24F 11/52; F24F 11/63; G05B 15/02; F24F 2110/10; G05B 2219/2642

(57) ABSTRACT

A central reservation system (CRS) reserves an organization's rooms and remotely controls HVAC components that service the rooms to offset temperatures on a programmed, variable offset temperature scale to optimize energy efficiency of the HVAC components. A building management system and the CRS also minimize current surging at a power grid powering the HVAC components at startup according to energy management protocols, in an attempt to limit current surging in a power grid supplying the HVAC components. Wireless thermostat devices/wireless adapters in each room are in wireless communication with the CRS server and the HVAC components, where a user application program is downloaded to a user hand-held electronic device when a user checks into a room to enable the user to communicate directly with the CRS server to control the HVAC components and temperature in the rooms.

### CROSS-REFERENCE TO RELATED APPLICATIONS

This application is a continuation-in-part (CIP) application of U.S. application Ser. No. 17/989,179, filed Nov. 17, 2022 (“the parent application”), which parent application is a continuation-in-part (CIP) application of U.S. patent application Ser. No. 17/672,816, filed Feb. 16, 2022 (“the grandparent application”), now abandoned; the grandparent application is a continuation application of U.S. patent application Ser. No. 16/842,913, filed Apr. 8, 2020 (“the great grandparent application”), which great grandparent application issued as U.S. Pat. No. 11,268,730, on Mar. 8, 2022; the contents of the parent, grandparent and great grandparent applications are incorporated herein by reference.

### BACKGROUND OF THE INVENTION

The invention broadly relates to heating, ventilation and air conditioning (HVAC) systems and, relates more particularly to a technical support system including a technical support device that is connected to wires of a conventional thermostat of an HVAC and/or HVAC/R system, and a hand-held electronic device, for monitoring and testing components of the HVAC and/or HVAC/R system normally controlled by the conventional thermostat, a technical adapter system including a technical adapter device that connects to a conventional thermostat of an HVAC and/or HVAC/R system, a hand-held electronic device, and monitoring devices, for controlling and/or, where necessary, overriding the conventional thermostat, thereby managing operation and energy efficiency of the HVAC and/or HVAC/R system components, and the heated and/or cooled space, in reliance upon monitoring data, a thermostat control system including a thermostat device, a hand-held electronic device, and monitoring devices, for controlling the HVAC and/or HVAC/R system components, thereby managing operation and energy efficiency of the HVAC and/or HVAC/R system components, and the heated and/or cooled space, in reliance upon monitoring data received from the monitoring devices, or other data available data; and an application program including a software component for operation in a hand-held electronic device, such as a smartphone, and/or a software component for operation in the technical support device and/or the adapter device and/or the thermostat device, and/or a software component for operation in server operating as a remote control center, where the components operate to allow a user to wirelessly control the respective technical support, technical adapter system and thermostat control systems, via respective hand-held electronic devices.

### SUMMARY OF THE INVENTION

The present invention overcomes the shortcomings of the prior art.

A benefit of the technical adapter system, including a technical adapter device and a hand-held electronic device, is that the technical adapter system avoids replacing existing conventional thermostats while upgrading into a wireless thermostat control of existing HVAC and/or HVAC/R system components. The technical adapter system improves efficiency of existing home/business HVAC and/or HVAC/R system components, enhancing their overall temperature control and power saving capabilities in spaces in which they operate and by enhancing a user's ability to control and manage HVAC system's energy efficiency therefor from anywhere off-site of the location.

In an embodiment, the invention provides a technical adapter system for wirelessly remotely controlling a conventional thermostat and/or components of an HVAC and/or HVAC/R system to which the conventional thermostat is connected, and optimizing energy efficiency of the HVAC system components, thereby effectively heating and/or cooling a space or volume that the HVAC and/or HVAC/R system is configured to heat and/or cool. This could include a number of hotel rooms, as a non-limiting example.

The technical adapter system comprises an adapter device including a processor, a memory and an adapter application program component. The adapter device is configured to connect to the conventional thermostat and/or the components of the HVAC and/or HVAC/R system, to control the conventional thermostat and/or HVAC system components. The technical adapter system includes a hand-held electronic device having a hand-held control device application program component that operates to enable the hand-held electronic device user to wirelessly connect to the adapter device, and remotely control and command the adapter device and, therefore, the conventional thermostat.

The adapter device is adapted to implement an override function that overrides the conventional thermostat setting to directly control the HVAC and/or HVAC/R components. The system may include a central management system, wherein the central management system comprises a computer server and a management system application program component, which, during operation, forms a direct communication with the hand-held control device application program component operational in the hand-held electronic device to effect thermostat control. Preferably, the adapter device is a stand-alone device that is mounted and connected directly to existing HVAC equipment.

The technical adapter system has a first connector that effects connection of the adapter device to the HVAC and/or HVAC/R system components and a second connector that effects connection of the adapter device to the conventional thermostat. The first and second connectors together effectively bypass the wire configuration between the conventional thermostat and the HVAC and/or HVAC/R system components. The technical adapter system may further include a technical support device configured to connect to conductors connecting the conventional thermostat to the HVAC and/or HVAC/R system components, wherein the technical support device includes means for communicating wirelessly to the hand-held electronic device and a support device application program component configured to be controlled by the hand-held control device application program component to implement monitoring functions, and testing functions, on the HVAC and/or HVAC/R system components and conductors.

The technical adapter system also may include one or more wireless HVAC interface devices configured for connecting to an HVAC and/or HVAC/R system component and wirelessly communicating to the hand-held electronic device and the hand-held control device application program component operational therein.

The technical adapter system also may include a wireless police lock with smoke and fire sensor configured for connecting to an HVAC and/or HVAC/R system component and wirelessly communicating to the hand-held electronic device and the hand-held control device application program component operational therein.

The technical adapter system also may include a package HVAC A/C condensing unit heat pump configured for wirelessly communicating heat pump data to the hand-held electronic device and the hand-held control device application program component operational therein.

The technical adapter system also may include at least one wireless GPS unit locator, the GPS unit locator configured for connecting to an HVAC system component and wirelessly communicating to the hand-held electronic device and the hand-held control device application program component operational therein to support identifying a location of said HVAC system component.

The technical adapter system also may include a magnet mounted external fuel tank sensor, adapted to be connected to a fuel tank, and configured for wirelessly communicating to the hand-held electronic device and the hand-held control device application program component operational therein an amount of fuel in the fuel tank.

The technical adapter system also may include a wireless occupancy proximity camera arranged to monitor persons coming and going from the space or volume for which the HVAC and/or HVAC/R system is intended to heat and/or cool, and for wirelessly communicating several persons and/or a time that each of a number or persons is present in the space or volume to the hand-held electronic device and application program component operational therein. Preferably, the adapter application program component, the hand-held control device application program component or both, implement a cycling function to optimize energy efficiency of the HVAC and/or HVAC/R system.

The cycling function relies on occupancy data, internal temperature conditions and real time whether conditions. For that matter, the adapter application program component, the hand-held control device application program component or both, modifies cycle rates along with temperature settings, during periods where the zone or space that the HVAC and/or HVAC/R system components are configured to heat and/or cool is occupied and unoccupied, using a preset sliding temperature scale of minimum and maximum range of settings by increasing or decreasing cycle rates based on time-varying parameters. The time-varying parameters are selected from a group consisting of: information of outdoor ambient temperature, received from local internet weather channels, current occupancy, motion sensors data, on board temperature sensors and remote proximity camera conditions.

During operation of an initial setup function, the adapter application program component, the hand-held control device application program component or both calculate HVAC and/or HVAC/R system component capacity required for conditioning occupied space based on square footage, and/or volume and/or minimum and maximum occupancy, to allow the adapter system to frequently adjust output rates during occupied and unoccupied periods, to optimize energy efficiency. The adapter device further includes on-board relays controlled by the adapter application program component to enable various types of control circuit wiring utilizing a single or dual, independent transformer circuit to energize cooling and heating when independent control power is required to connect auxiliary, boilers, remote duct heaters, boiler pumps and other heating devices for heating applications without requiring additional isolation relays. Preferably, the adapter device includes on-board relays to operate heat pumps using two independent transformers, a primary transformer to operate the basic heat pump, while the second transformer operates auxiliary heating devices to reheat cold air flow during a defrost cycle of a heat pump system, and wherein during a defrost cycle, accepts defrost control power signals from the heat pump defrost master to manage the heating circuits.

In another embodiment, the invention provides a wireless thermostat system for remotely controlling components of an HVAC and/or HVAC/R system, manually or automatically, to optimize energy efficiency of the HVAC and/or HVAC/R system components and a space or volume of which the HVAC and/or HVAC/R system components are arranged to heat and/or cool. As such, the wireless thermostat system includes an inventive thermostat device configured to wirelessly connect to the components of the HVAC and/or HVAC/R system. The thermostat device includes a thermostat application program component that is operated to control the HVAC and/or HVAC/R system components. The wireless thermostat system also includes a hand-held electronic device with a hand-held control device application program component that is operated to enable a hand-held electronic device user to wirelessly connect to and communicate with the thermostat application program component operational in the thermostat device.

Based upon sensor data derived either from the space or volume, or available from an outside data source, the thermostat device and/or hand-held electronic device application program components effectively control the thermostat device and/or the HVAC and/or HVAC/R system components. Preferably, the wireless thermostat system includes a central management system comprising a computer server and a management system application program component that is operated to communicate with the hand-held control device application program component operational in the hand-held electronic device and control the hand-held control device application program component, the thermostat device application program component or both. Alternatively, the computer server and a management system application program component may communicate directly and thereby directly control the inventive thermostat device.

The wireless thermostat system is programmed to maintain optimal HVAC cycle rates along with opening and closing time temperatures for the space or volume. The system monitors to determine a closely approximated number of persons present in an area within the space or volume and adjusting a cycle rate for heating and or cooling while keeping the temperature within a predetermined range. Capacity control is accomplished by activating multiple stages of cooling or heating and reducing or increasing the cycle rates of the HVAC system. The cycle rates derive from detected temperature patterns of a target area. The wireless thermostat device can exercise HVAC system components to test and ensure reliable operations. The computer server operates as a central communications hub of which both the wireless thermostat and hand-held control device relies for communication.

In an embodiment, the invention provides a technical support system for monitoring and testing components of an HVAC and/or HVAC/R system that are normally controlled by a conventional thermostat. The technical support system comprises a technical support device including a processor and a memory and a hand-held electronic device. The technical support device is configured to enable connection to a conventional thermostat that is connected to the components of the HVAC and/or HVAC/R system and is programmed to implement monitoring and testing functions on the HVAC system components and/or on conductors connecting the HVAC and/or HVAC/R system components. The hand-held electronic device or smartphone is programmed to enable wireless connection to the technical support device to remotely control the technical support device, including remotely executing the monitoring and testing functions relating to the HVAC system components.

The technical support device is connected to a control terminal strip of the conventional thermostat, and preferably includes a display touch pad, and is programmed to present display screens that allow touch input by a user to directly control the technical support device to execute the monitoring and testing functions.

In an embodiment, the invention provides a central reservation system (CRS) configured to reserve an organization's rooms and remotely control temperatures in the rooms by controlling HVAC components that service the rooms according to a programmed, variable offset temperature scale, optimizing energy efficiency of the HVAC components according to energy management protocols. The CRS comprises a CRS server in operating a CRS application program that manages reservations for the organization's rooms, and a CRS server plugin that operates with the CRS application program to remotely control of the HVAC components and offset temperatures in the rooms, a thermostat device or thermostat adapter arranged in each of the organization's rooms in communication with the CRS server and with the HVAC components and
a user application program for download to a user hand-held electronic device during a room check in, wherein the user application program is operated to enable the user to communicate directly with the CRS server and, therefore, the thermostat device to control the HVAC components to efficiently control the temperatures in the rooms.

The thermostat device or thermostat adapter are wireless, where the user application program enables communication between the user hand-held electronic device and the wireless thermostat device and/or wireless adapter. The CRS may further include at least one sensor arranged in each of the organization's rooms in communication with the thermostat device or thermostat adapter for detecting operational conditions and communicating the detected operational conditions data to the CRS server, such that the CRS server can override current set data for the room based on the detected operational conditions data. The CRS server memory may store the detected operational conditions data, data from an outside data source, thermostat device or adapter data and/or user input data so that said operational conditions data are accessible for processing. The CRS server controls the HVAC components through control of the thermostat device or thermostat adapter in each of the rooms to a first environmental room state reflecting non-reservation, a second environmental state reflecting a time between reservation and check-in, a third environmental state reflecting a time between user check-in and check-out in which the user is present and a fourth environmental state reflecting a time between user check-in and check-out in which the user leaves the room temporarily.

For that matter, users may use the user application program to override the temperature setting for the room during the third environmental state. Users may make a reservation through an organization's server in communication with the CRS server or through the CRS server. Preferably, the CRS server communicates with the user application program if downloaded and operational in a user's hand-held electronic device. At least one sensor can include a motion sensor that generates sensor data which is processed by the CRS server to control a room's temperature during each of the first, second, third and fourth environmental states. If the organization includes an energy center that operates based on an estimated aggregate load on the energy center, which reflects a required energy cost to maintain the organization's rooms, the CRS server may operate modify a capacity for said estimated aggregate load if the CRS server an actual aggregate load changes at least a set minimum amount.

In one form, the user, via the user application program operating in the user electronic device may automatically override a room's current thermostat or adapter settings to adjust the room temperature, independent of energy efficiency. The CRS server communicates with to control the wireless thermostat devices or adapters and at least one sensor arranged in the rooms to manage and adjust average hourly HVAC cycles, and system component run times during occupied and unoccupied time periods for each of the reserved rooms. The central reservation system (CRS) monitors the reserved rooms in reliance upon the thermostat devices or thermostat adapters and sensors and generates and sends an alert in response to detection of a temperature that is too high or too low in view of the stored data. Use of the CRS server required payment of a monthly subscription fee based on a number of thermostat devices or thermostat adapter devices operated by an organization, whether wireless or hardwired.

Preferably, the thermostat devices and thermostat adapters are wireless, wherein the wireless thermostat devices or wireless thermostat adapters include GPS capability are identified by respective serial numbers and respective identities of each room in which they are installed, the room numbers and serial numbers are memory stored and the installed locations of the wireless thermostat devices or wireless thermostat adapters defined by its GPS coordinates and wherein the CRS server is programmed or ping one or more wireless thermostat devices or wireless thermostat adapters to return an actual GPS location, compares the actual GPS location with the stored GPS location, and determines if they are different. The CRS server generates and sends a notice to the registered owner of the wireless thermostat device or wireless thermostat adapter where GPS locations are determined to be different.

In an embodiment, the invention provides a building management system (BMS) configured to manage a structure associated with an organization and organization rooms arranged within the structure, remotely control HVAC components arranged to service the rooms by controlling offset temperatures in the rooms on a programmed, variable offset temperature scale to optimize energy efficiency of the HVAC components according to energy management protocols. The BMS comprises a BMS server operating a BMS application program and a BMS server plugin that operates with the BMS application program to define room temperatures based on conditions data and effect remote control of the HVAC components and offset temperatures in the rooms according to the energy management protocols, a thermostat device or thermostat adapter that connects to the BMS server and to the HVAC components, the thermostat device or thermostat adapter including an operational thermostat application program operated to communicate with the BMS application program and to control the temperature and HVAC components to optimize energy efficiency of the HVAC components, a user application program for download to a user's hand-held electronic device to enable a user of the electronic device to wirelessly connect to the BMS server and/or the thermostat device or thermostat adapter and at least one sensor arranged in each of the organization's rooms in communication with the thermostat device or thermostat adapter to detect conditions in the rooms and provide detected conditions data to the BMS server for processing.

The thermostat application program component or the BMS plugin processes the conditions data, data available from an outside data source, including up to date weather data, sensor and/or user data to manage and adjust to optimize HVAC cycles, average hourly time cycling periods, and system component run times during occupied and unoccupied time periods. The thermostat devices or thermostat adapters are wireless, include GPS capability, are identified by respective serial numbers, all rooms have a fixed GPS location, wherein the rooms and thermostat devices or adapters room locations and serial numbers memory stored and wherein the BMS server is programmed to ping one or more wireless thermostat devices or wireless thermostat adapters to return a GPS location of the devices or adapters, and compare the actual GPS locations with the stored GPS locations, and determine if they are different. The BMS server is located at a different location than the building, the building includes a building server, the BMS server is in communication with the building server, and wherein the BMS server generates and sends a notice to the registered owner of the wireless thermostat device or wireless thermostat adapter, and/or the building server, in an event in which the GPS locations are determined by the BMS application program and/or the user application to be different.

In an embodiment, the invention provides a building management system (BMS) for managing environments in each room of a plurality of rooms within one or more buildings that are environmentally controlled by separate, remotely controllable HVAC components arranged to service said each room of the plurality of rooms, including controlling offset temperatures in each said room on a programmed, variable offset temperature scale to optimize energy efficiency of the HVAC components according to energy management protocols, including controlling times in which the HVAC components startup, sequentially and/or in parallel, to minimize or otherwise limit electrical current surging to effect said HVAC-component startup.

The BMS should include a BMS server operating a BMS application program and may further include a BMS server plugin to set an operating temperature in each room or the plurality of rooms based on conditions data and for controlling the HVAC components to realize the set operating temperatures according to the energy management protocols to minimize electrical current surging at HVAC-component startup. a thermostat device arranged in each of the plurality of rooms that connects to the BMS server and to the HVAC components, and that includes a processor that operates a thermostat application program enabling the BMS application program to control power driving the HVAC components to optimize energy efficiency and minimize electrical current surging at HVAC-component startup, while maintaining the energy management protocols.

Preferably, means for users controlling the BMS application program are included. At least one sensor arranged in each of the plurality of rooms in electrical or electronic communication with the thermostat device to detect environmental conditions in the rooms and provide detected conditions data to the BMS application program for processing. The BMS application program preferably also processes available data concerning surge timing at startup for any of the HVAC components called upon to startup. The means for controlling the BMS application program comprises a user application program, operational in a user electronic device such as a cell phone, tablet, laptop, etc. . . . The thermostat application program component or the BMS plugin processes the conditions data, data available from an outside data source, including up to date weather data, sensor and/or user data to manage, electrical grid data, and current surge data for the HVAC components controlled to startup and based thereon, to adjust to optimize HVAC cycles, startup timing of each HVAC component, average hourly time cycling periods, and system component run times during occupied and unoccupied time periods in each of the rooms.

The thermostat device is wireless, includes GPS capability, is identified by a serial number, wherein each room of the plurality of rooms has a fixed GPS location, wherein the BMS server is programmed to ping each wireless thermostat device to return a GPS location of the wireless thermostat device and to compare actual GPS locations with the fixed GPS locations and determine if they are different. The BMS server and/or BMS application program include operating capability of controlling power used by the HVAC components and wherein the BMS server includes an artificial intelligence (AI) based system trained to find and provide accurate cycle data reflecting optimal re-start time period rates, reflecting surging current needs for the HVAC-startup components and utilizing said data to coordinate startup of multiple HVAC components to reduce amperage surging of the power grid supplying the startup currents.

The artificial intelligence (AI) system accesses HVAC system cycle data, surging current profiles and other operating data for the HVAC components and presents the accessed HVAC system cycle data and surging current profiles for processing by the BMS application program. For that matter, the artificial intelligence (AI) system learns statistical power usage from the HVAC component operating profiles, HVAC component cycling profiles and cycling, and wherein the BMS compares run time and surging current times of each HVAC component when starting up in a fixed, electrical energy grid, or in a plurality of specific energy grids, and staggers startup of at least one of the HVAC components to minimize energy grid surging at startup. The building management system (BMS) relies upon the operating cycle time of each HVAC component to reach and satisfy predetermined temperature set points in each of the rooms of the plurality of rooms.

The AI system selects optimum system thermostats run time increasing cycle restart of those systems that run optimally, thereby reducing the power surge effect. The building management system (BMS) preferably includes or embodies a central reservation system (CRS), including a CRS server, wherein users may make a reservation through the the CRS server. The central reservation system (CRS) server communicates with to control the wireless thermostat devices and at least one sensor arranged in the rooms to manage and adjust average hourly HVAC cycles, and system component run times during occupied and unoccupied time periods for each of the reserved rooms. The central reservation system (CRS) monitors the reserved rooms in reliance upon the thermostat device and sensors and generates and sends an alert in response to detection of a temperature that is too high or too low in view of the stored data. Use of the CRS server may require payment of a monthly subscription fee based on a number of thermostat devices or thermostat adapter devices operated by an organization, whether wireless or hardwired.

In the building management system (BMS), the artificial intelligence (AI) system learns statistical power usage from the HVAC component operating profiles, HVAC component cycling profiles and cycling, and wherein the BMS compares run time and surging current time durations of each HVAC component when starting up in the electrical power generating and distribution system supplying the BMS-controlled HVAC components, or in a plurality of electrical power generating and distribution systems, and staggers startup of at least one of the HVAC components to minimize energy surging at startup to avoid electrical power surging in the electrical power generating and distribution system, to limit electrical current surging in a power generating and distribution system powering the HVAC components. The sliding scale is based on the most efficient detected to startup and reach temperature set points in a shortest amount of time to least efficient HVAC components that are detected to startup and reach temperature setpoints in a longest time, or the plurality of HVAC components.10. The building management system (BMS) of claim 8, wherein the BMS system relies upon the operating cycle time of each BMS-controlled HVAC components operating as a wide area network to reach and satisfy predetermined temperature set points in each of the rooms of the plurality of rooms and to minimize surging in the electrical power generating and distribution system supplying the BMS system.

The AI system selects optimum system thermostats run time by increasing cycle time holding back cycle restart on the sliding scale of those HVAC components that run optimally, thereby reducing a power drain by inefficient HVAC components. The BMS system communicates with and controls the wireless thermostat devices and at least one sensor arranged in the rooms to manage and adjust average hourly HVAC cycles, and HVAC component run times during occupied and unoccupied time periods for each of reserved rooms, of the plurality of rooms, in an effort to minimize surging. The BMS system monitors the reserved rooms including the HVAC component(s) associated with reach of the reserved rooms in reliance upon the thermostat device and sensors and generates and sends an alert in response to detection of a temperature that is too high or too low in view of the stored data, in an effort to limit voltage drops and surging.

A startup time of HVAC components that require a substantial amount of current at startup, and a longer application of said substantial amount of current at startup, is postponed at least 10 seconds.

In an embodiment, the invention presents an electrical power generating and electrical power delivery system in a form of a plurality of local electrical power substations, the system configured to compensate for power surging in the substations. The system comprises a processor; and a memory. The memory includes computer readable instructions that are processed to implement monitoring for power surging in the substations. If power surges in one substation, the processor compels one of the other substations to make current available to compensate for at least part of the detected current surging. The substations each supply commercial users, including commercial buildings managed by building management systems.

The building management systems (BMS) manages environments comprising locations at which separate, remotely controllable HVAC components are located, the HVAC component arranged to control temperature conditions in each room of a plurality of rooms within one or more buildings, including controlling offset temperatures in each of the locations on a programmed, variable offset temperature scale to optimize energy efficiency of the HVAC components according to energy management protocols, including controlling times in which the HVAC components startup, sequentially and/or in parallel, to minimize or otherwise limit electrical current surging to effect said HVAC component startup in any substation.

The BMS system comprises a BMS server operating a BMS application program and a BMS server plugin to set an operating temperature in each of the HVAC component locations based on conditions data and for controlling the HVAC components to realize the set operating temperatures according to the energy management protocols to minimize electrical current surging at HVAC-component startup; a thermostat device arranged in each of the locations of the HVAC components that connects to the BMS server and to the HVAC components, and that includes a processor that operates a thermostat application program enabling the BMS application program to control power driving the HVAC components to optimize energy efficiency and minimize electrical current surging at HVAC-component startup, while maintaining the energy management protocols; means for users controlling the BMS application program; and at least one sensor arranged in each of the plurality of rooms and in each of the plurality of spaces and in electrical or electronic communication with the thermostat device to detect environmental conditions in the rooms and/or the spaces and provide detected conditions data to the BMS application program for processing. The BMS application program also processes available data concerning surge timing at startup for any of the HVAC components called upon to startup.

The one or more building comprise any of the group consisting of private home, condominium complexes. Cooperatives, business structures, hotels, motels, commercial buildings, industrial buildings, and schools. The building management system (BMS) of claim 8, wherein the sliding scale is based on the most efficient detected to startup and reach temperature set points in a shortest amount of time to least efficient HVAC components that are detected to startup and reach temperature setpoints in a longest time, or the plurality of HVAC components.

### BRIEF DESCRIPTION OF THE DRAWINGS

The invention will be described in conjunction with the following drawings in which like reference numerals designate like elements and wherein:

FIG. 1 presents an exemplary embodiment of the technical support system of the invention;

FIG. 2 presents an exemplary embodiment of the technical adapter system of the invention;

FIG. 3 presents an A/C, gas warm air, heat pump wiring arrangement for use with the technical adapter system depicted in FIG. 2;

FIG. 3A presents an A/C, gas warm air, boiler wiring arrangement for use with the technical adapter system depicted in FIG. 2;

FIG. 4 presents details of the adapter device in communication with other adapter system elements, and HVAC system components, according to the invention;

FIG. 5 presents an embodiment of a wireless thermostat system of the invention, including a wireless thermostat;

FIG. 6 depicts one embodiment of the wireless thermostat included in the wireless thermostat system;

FIG. 7 depicts a central reservation system (CRS) that includes a CRS server operating a CRS application program with a CRS plugin, or a CRS application program with code that operates to implement the CRS plugin function, both enabling the CRS server operation that offsets temperature in a space or volume (i.e., rooms or apartments within a building such as a hotel or cooperative apartments), optimizing energy efficiency of HVAC components servicing the space or volume (e.g., rooms), according to the inventive principles; and

FIG. 8 depicts a building management system (BMS) that includes a BMS server operating a BMS application program with a BMS plugin, or a=BMS application program with code that operates to implement the BMS plugin function, both enabling the BMS server operation that offsets temperature in a space or volume (i.e., rooms or apartments within a building such as a hotel or cooperative apartments) to optimize energy efficiency of the HVAC components servicing the space or volume (e.g., rooms), according to the inventive principles.

### DETAILED DESCRIPTION OF THE INVENTION

The following is a detailed description of example embodiments of the invention depicted in the accompanying drawings. The example embodiments are presented in such detail as to clearly communicate the invention and are designed to make such embodiments obvious to a person of ordinary skill in the art. However, the amount of detail offered is not intended to limit the anticipated variations of embodiments; on the contrary, the intention is to cover all modifications, equivalents, and alternatives falling within the spirit and scope of the present invention, as defined by the appended claims.

### Technical Support System

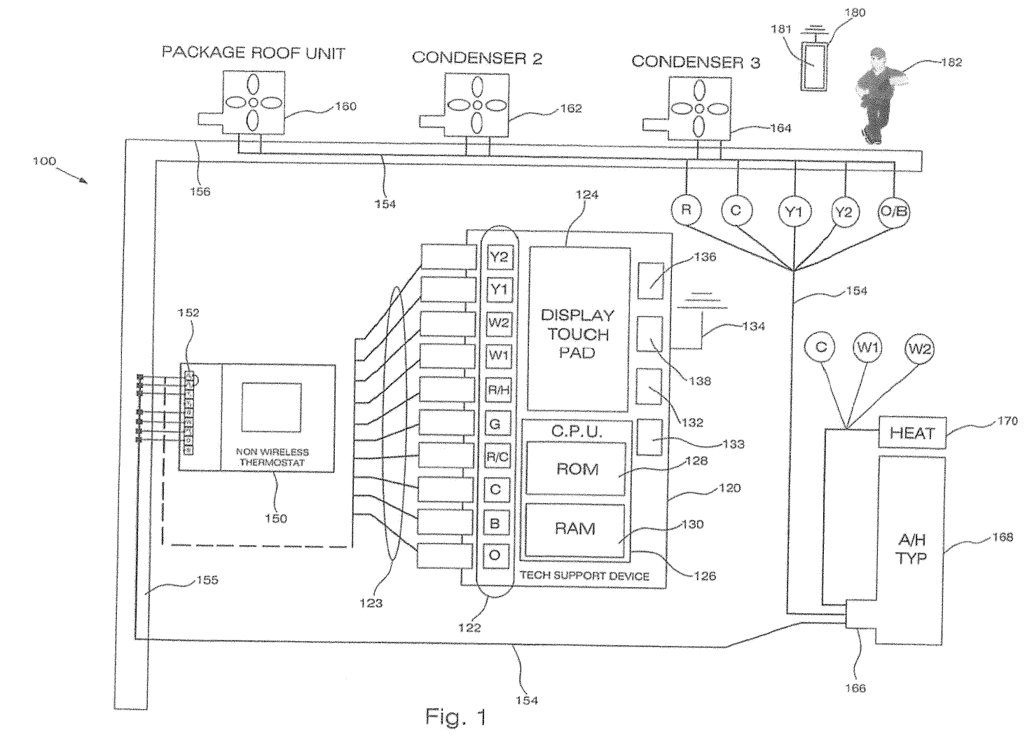

In a first embodiment, as depicted in FIG. 1, the invention provides a technical support system 100, including a technical (“tech”) support device 120 configured to connect to wires connecting a conventional thermostat of an HVAC and/or HVAC/R system to the HVAC and/or HVAC/R system components, and a hand-held electronic device 180. Common HVAC system components are known to include cooling or air conditioner (“AC”) components, such as “package roof unit” 160, “condenser 2” 162, “condenser 3” 164, a control junction 166 for an air handler 168, a heating unit or coil 170, etc., without limitation. Please note that hereinafter, the term “HVAC” shall be used to refer to HVAC or HVAC/R and both HVAC and HVAC/R. The technical support system 100 is configured for monitoring and testing components the HVAC system components, which are normally controlled by the conventional thermostat.

The technical supporter system 100 includes a technical support device (technical supporter or tech supporter) 120 and a hand-held electronic device 180. The technical support device 120 is adapted to temporarily connect to the control terminal strip 152 of the conventional thermostat 150 via a set of jumper wires 123 (or the like). The control terminal strip 152 connects to the existing thermostat wiring, which is typically found in a wall 155 or ceiling 156 of a house, business or apartment building (hereinafter referred to in the aggregate interchangeably as “building”) in which components of the HVAC system are installed. The reader should note that while the jumper wires 123 are shown connected to the control terminal strip 152 of conventional thermostat 150, the jumper wires 123 also may be connected directly to the existing wires 154, as known to those with ordinary skill in the art.

The hand-held electronic device 180, may embody a smartphone, computer tablet, computer laptop or other hand-held control device as long as the hand-held control device hand-held electronic device can electronically communicate, for example, with another hand-held electronic device or the technical supporter 120, remotely, for example, via the Internet. Hence, a user 182 may use the hand-held control device 180 to remotely operate and test the components of the HVAC system in reliance upon the technical supporter 120, for example, while moving around the building or home from various locations. The technical support device 120 is controlled indirectly by the hand-held control device 180 to implement test routines to test the HVAC system and system components for shorted wires, continuity, defects in relays, interfaces, power supplies, faults in the wiring 123, 154, the thermostat 150, control terminal strips (such as control terminal strip 152), HVAC system components (for example, 160, 162, 164, 150, 152, 154), etc. (without limitation). The technical supporter device 120 then transfers related testing data wirelessly to the hand-held control device 180, for processing and/or communication, thereby, as needed.

As shown in FIG. 1, the technical supporter device 120 includes, without limitation, a control terminal strip 122, connected to the jumper wires 123, a display device (e.g., a “display touch pad”) 124, a central processing unit (“CPU”) 126, a read-only memory (“ROM”) 128, a random access memory (“RAM”) 130, and I/O device or module 132, a MODEM 133 and an antenna or other means for communicating 134, such as via Wi-Fi, as shown. The ROM 128 can store the instructions comprising the software component of the application program operational in the tech support device. And while FIG. 1 shows the ROM 128 and RAM 130 as part of the CPU 126, these also may be separate elements connected to the CPU 126, for example, via a bus (not shown), without deviating from the spirit of the invention. I/O device or module 132 communicates with an antenna 134 for sending and receiving signals to/from the hand-held control device 180, for example, via a router, or like device, and the Internet.

During intended operation, the user 182 has a choice with on board selector mode switches (physically present on the technical support device 120) to randomly select the conductors (e.g., wires 154 of the HVAC system he/she chooses to check). This also may be accomplished with “virtual” selector mode switches presented by the display touchpad 124 (not shown), implemented by the software component operational therein, and/or by the physical switches at the technical support device (not shown), by which the conductors (or wires) may be selected for testing directly at the actual physical selector mode switches. The technical supporter device 120 and related software application enable users to select modes to check for power-related faults, shorts, continuity issues, open conductors, relay coil operability, etc., in the HVAC system, and send data results to the hand-held control device or energy management system operational at a remote server.

The technical supporter device 120 also implements a mode function and includes a corresponding mode actuation “button” 136. Mode actuation button 136 may be as an actual physical button (as shown in FIG. 1) or may be a virtual button that is presented or displayed on the display touch pad 124 or on display 181 of the hand-held control device 180. The mode actuation button 136 enables a user to activate various sub-functions that energize individual HVAC system components, such as fans, heat units, compressors, reversing valves on heat pump systems independently of one another, and view actual functions remotely.

So, for example, if a user is outside of the space heated and/or cooled by the HVAC system, or on a roof of the building bounding the space, he/she can trigger and energize, for example, the air handler 162 or other HVAC components for testing, etc. Preferably, the technical support device 120 includes a temperature sensor 138, which is either part of the actual CPU (not shown) or coupled to the CPU. Additionally, the mode function (activated using mode actuation button 136), enables the user to join all necessary HVAC system components for testing and operation.

### Technical Adapter System

In another embodiment, the invention provides a technical adapter system 200 including a technical adapter device configured to connect to a conventional thermostat of an HVAC and/or HVAC/R system, a hand-held electronic device, and monitoring devices, the technical adapter system configured for controlling and/or, where necessary, overriding the conventional thermostat, thereby managing operation and energy efficiency of the HVAC and/or HVAC/R system components, and the heated and/or cooled space, in reliance upon data received from the monitoring devices, or other available data.

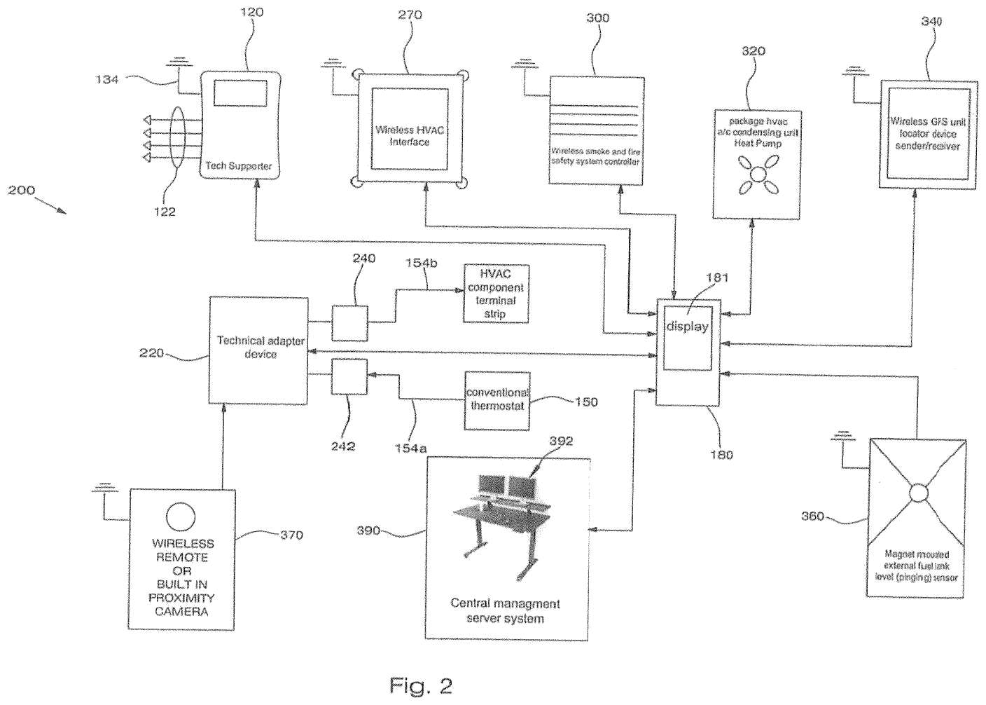

FIG. 2 presents an exemplary embodiment of the technical adapter system 200, as well a conventional thermostat 150, and several HVAC system components. The technical adapter system 200 includes an adapter device 220 (referred to interchangeably hereinafter as “adapter”), a first connector 240 for connecting the adapter device to existing field wires 154b, which connect to various HVAC system components, a second connector 242, for connecting the thermostat 150 to the adapter device 220 via wires 154a, a hand-held electronic device 180, a tech supporter device 120, wireless HVAC interface 270 (installed at HVAC system components), a wireless police lock and smoke and fire sensor system 300, a package HVAC a/c condensing unit heat pump 320, a wireless GPS unit locator 340 (installed at HVAC system components) and magnet mounted external fuel tank level (pinging) sensor (or sensor system) 360 (installed on a fuel tank as the case may be), a wireless occupancy proximity camera 370, and a central management system 390, comprising a central management system server 392 (at times referred to herein as “cloud server”) in which a set of instructions comprising an application program implementing system management control is operational.

The thermostat 150 is previously hardwired (via existing thermostat wires 154 (FIG. 1) or 154b (FIG. 2) to the heating and/or cooling components of the HVAC system. The technical adapter 220 includes the same hardware components, and stores and processes computer instructions for operating a similar application program component as the technical supporter 120, described above, but for the interactive display device 124 and an ability to implement the above-described testing and control therethrough. That is, the software component operational in the adapter device 220, while capable of carrying out many of the functions implemented by the technical support device 120, does not normally implement instructions that normally rely on a display touch pad 124. The adapter device 220 also wirelessly communicates with a hand-held control device 180, for example, via MODEM 133 and antenna 134, and the remote energy management system 390 operating on central management system server 392.

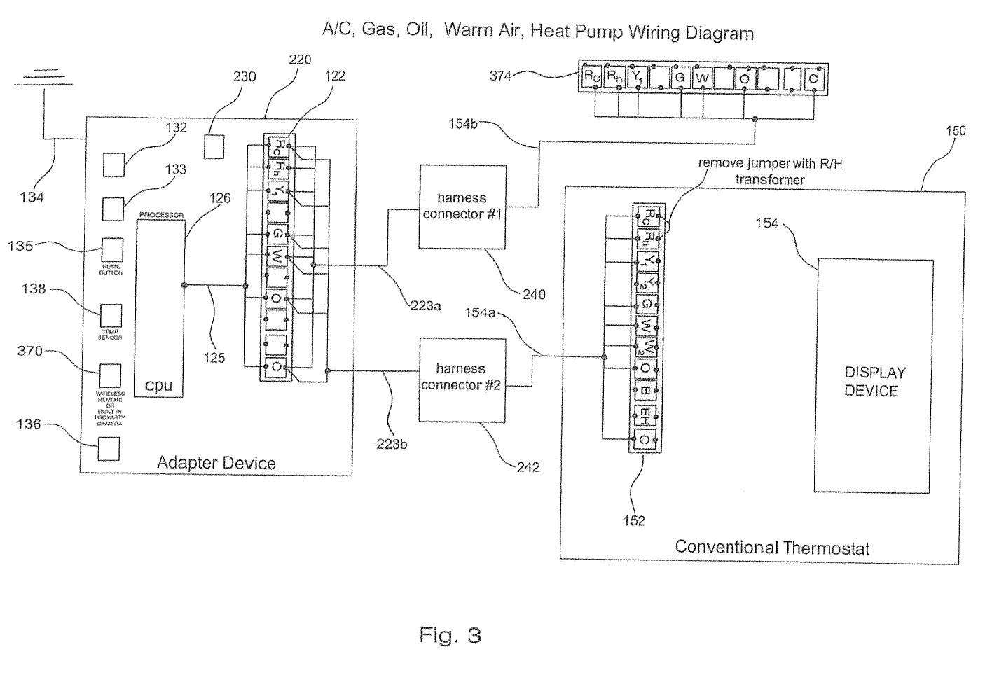

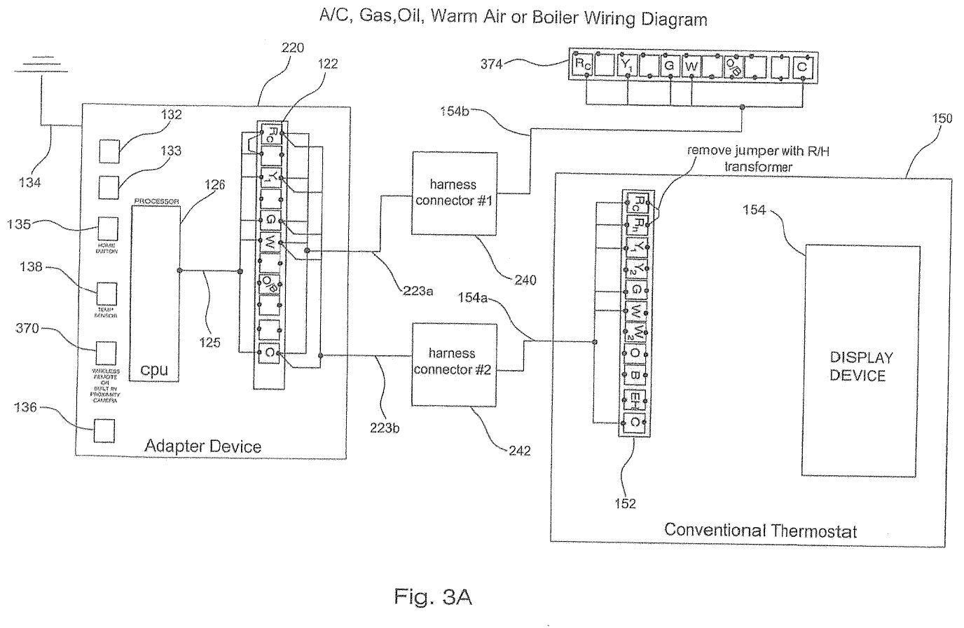

As shown in detail in FIG. 3 (A/C, Gas, Oil, Warm Air, Heat Pump Wiring Diagram), the first connector 240 and second connector 242 essentially are wiring harnesses. The first connector 240 is connected to the adapter device 220 via wires 223a and control terminal strip 122, and to the existing field wires 154b to the various HVAC system components, represented by HVAC control terminal strip 374. The second connector 242 is connected to the adapter device 220 via wires 223b and control terminal strip 122, and to the control terminal strip 152 of thermostat 150, also via existing field wires 154a. The signals that pass through the first and second connectors pass from the control terminal strip 122 to the CPU 126 for processing, either directly hardwired or coupled through a bus 125. The CPU 126 (preferably through an internal bus) exchanges signals with the hand-held control device 180 wirelessly, for example, through the I/O (input/output) device 132, MODEM 133 and antenna 134. The adapter device 220 operates to control the HVAC system (i.e., the individual HVAC system components) as a primary control by controlling the conventional thermostat 150.

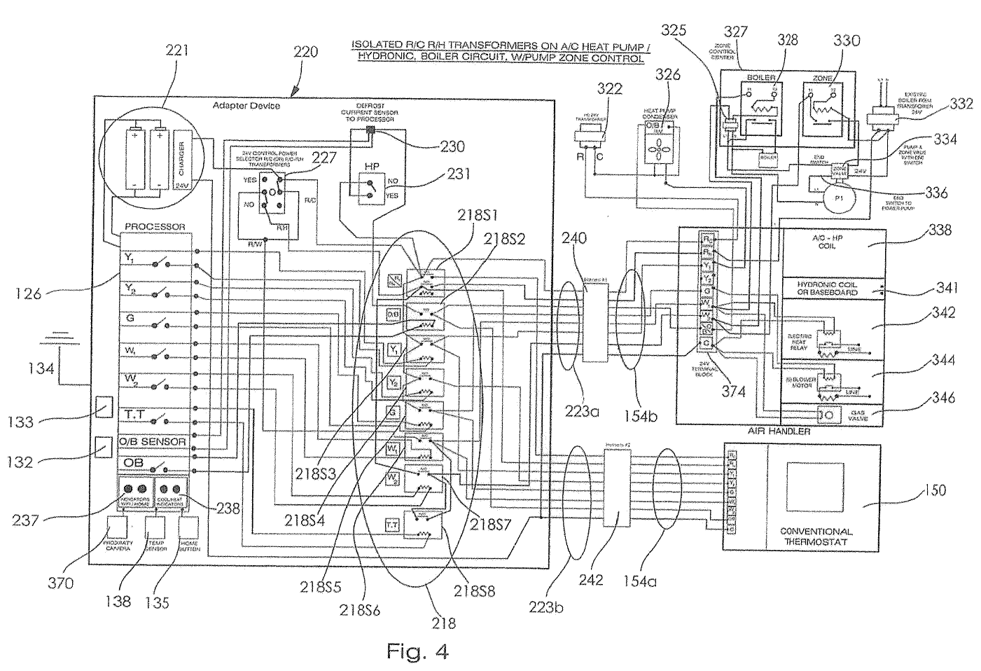

In addition, the adapter device 220 includes micro dip switches (not shown expressly in FIG. 3) to enable set-up of isolated circuits having separate transformers, usually found on boilers that require dry contacts to make. The adapter device 220 can be configured to operate to control the HVAC system components indirectly by controlling the existing thermostat 150, for example, which controls an HVAC system with a primary transformer 322, a heat pump condenser 326, a zone control center 327, which includes boiler 328 and zone switch 330, as shown in FIG. 4. Also shown in FIG. 3 are an existing boiler room transformer (24V) 332, a pump & zone valve with end switch 334, an end switch to power pump 336, an A/C-HP coil 338, a hydronic coil or baseboard 341, an electric heat relay 341, a (G) blower motor 344 and a gas valve 346. FIG. 4 (Isolated R/C R/H transformers on A/C Heat Pump/Hydronic, Boiler Circuit, w/Pump Zone Control) depicts an a/c/heat pump wiring diagram with boiler single or dual transformer control. Such arrangement enables the HVAC system (and system components), in reliance upon the inventive technical adapter device 220, to operate dual fuel systems, using, oil, gas, electric, hydronic heat coil system combination, without having to add additional isolation relays or aquastats. By setting the micro dip switches 218, i.e., R_{c}/R_{H} 218S1, O/B 218S2, Y1 218S3, Y2 218S4, G 218S5, W 218S6, W2 218S7, and T.T 218S8, a user can, for example, isolate the R/H heating transformer circuit and allow the R/C primary transformer to operate a heat pump requiring the R/C transformer power, with a separate R/H transformer in tandem that feed separate heating control circuits. Put another way, the micro dip switches 218S1-S8, when set, allow the CPU 126 to actuate the corresponding relays (R_{C}/R_{H}, Q/B, Y₁, Y₂, G, W₁, W₂, and T.T). The user can implement a dry relay circuit or combine the R/H and R/C circuits to operate as one transformer system, in reliance upon switch 218s1 as shown.

The (W) circuits for heating can also be set up to control any low voltage circuits having separate 3rd transformer systems (see, for example, zone panel 327 of FIG. 4) that are sometimes found in integral duct or air-handler electric re-heat or auxiliary systems using the T.T dry contacts in systems that are integrally powered with their own control power transformer. Please note that the adapter device 220 also includes an optional battery charger 221, a 24V control power selector R/C (or) RVC-RH transformers 227, a defrost current sensor to processor or CPU 230, and heat pump (HP) switch 231 directly connected to the processor or CPU 126, and respective Wi-Fi/Home and Cool/Heat indicator lights 237, 238, controlled by the CPU.

The wireless adapter device 220 also provides basic thermostat functions, as well as 7 day programmable scheduling. As the preferred embodiment of the adapter device 220 does not have a display device, for example, as do the technical supporter 100 and the thermostat device 420 (see below), the wireless adapter 220 may be said to be designed as a “black box”' product (sometimes referred to as a “headless” device). No display device means no control panel in the device (220) itself, other than the home over-ride switch 135. Use of the adapter device 220 can prevent misuse of temperature set points by renters/tenants, i.e., from overriding temperature set points beyond allowable ranges, typically when the renter/tenant is not responsible for heating costs.

There are many advantages by upgrading an existing HVAC system's conventional thermostatic control by implementing and using the technical adapter system 200, the least of which is being able to wirelessly control HVAC system component operation wirelessly for remote control, testing and trouble shooting. For example, a user/owner of a rental space within which the technical adapter system 200 and adapter device 220 is installed can remotely allow a minimum to maximum temperature set point range for tenants use in the rental space (or zone) for any reason to over-ride set-back modes. The adapter device 220 also allows an owner to block the “home” override button 135, for example, when “misuse” is detected, for example, by the on-board temperature sensor of the adapter device. The adapter home button 135 enables a user to control their conventional thermostat 150. While in home mode, the occupant controls their original thermostat to control the system setting, while the adapter device 220 remains connected to the cloud server 392 and continues to monitor temperature and equipment status locally. In case where the occupant is unable to, home mode can be switched either at the adapter device 220, or remotely over the Internet.

The conventional thermostat 150 to which the adapter device 220 is connected, is controlled via the component of the application program operational in the hand-held control device 180, in reliance upon control signals transmitted wirelessly. Once the adapter device 220 is installed in an HVAC system, the user still can use the previously-installed conventional thermostat 150 or switch over to Wi-Fi control using the adapter device 220 commanded by the hand-held control device 180. The adapter device 220 is adjusted from anywhere using the hand-held control device 180. Moreover, at any time, the user can switch control back (via the hand-held control device 180 or the physical buttons on the adapter device 220) to their conventional thermostat 150 for safety and backup operation of their HVAC system (for example, via the home button 135 on the adapter device).

The application program turns a user's smart phone, i.e., hand-held control device 180, into what is essentially a virtual thermostat controller, in reliance upon the virtual control mechanisms presented as display images on the hand-held control device s′ display device 181. The adapter system 200, through the hand-held control device 180, maintains communication and control of the adapter device 220, and therefore, the conventional thermostat 150 at the user' home or business in which the adapter device is installed/connected to the existing thermostat.

### Wirelessly

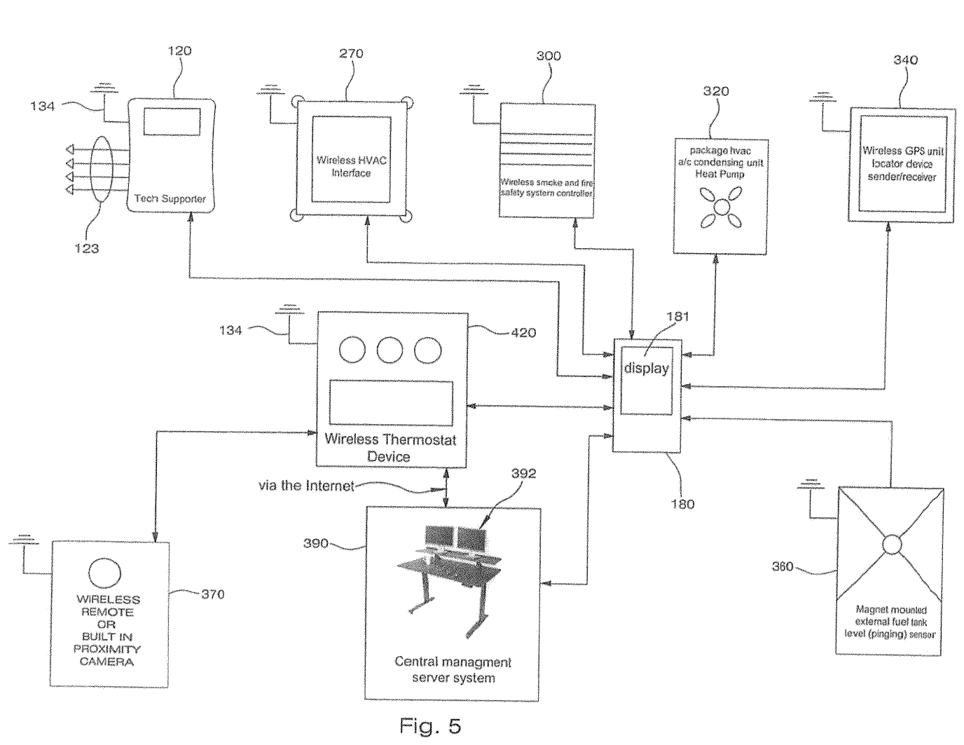

As shown in FIG. 2, the technical adapter system 200 is connected or coupled to wireless police lock with smoke & fire sensor system 300 (FIG. 2). The wireless police lock with smoke & fire sensor system 300 operates with the adapter device 220 (and/or the wireless thermostat (COBRA™) module depicted in FIG. 5) to add a security feature to the inventive adapter system 200. For example, the wireless police lock with smoke & fire sensor system 300 might be used with a homeowner's garage door to thwart known cases where burglars might capture a homeowner's garage door access code and use same for illegal garage entry. The wireless police lock with smoke & fire sensor 300 also includes a smoke detector element and fire sensor element. For safety reasons, the wireless police lock with smoke & fire sensor system includes an override so people on the premises can exit in a hurry in an emergency, and a loss of power. The wireless police lock with smoke & fire system is not limited to associated secondary smoke/fire dampers, first doors, entrance, exit, garage doors, circulator pumps, electrical switches, power outlets.

The adapter system 200 also is shown connected to a package HVAC A/C condensing unit A/C, heat pump 320. The adapter system 220 operates with the wireless thermostat cobra module depicted in FIG. 5)).

The adapter system 200 also is shown attached to wireless GPS unit locator 340 installed in or proximate to an HVAC system component, as shown in FIG. 2. The wireless GPS unit locator 340 operates with the adapter device 220 with a dedicated pairing identity serial number of wireless thermostat device (FIG. 4; 420) and the Central management server system depicted in FIGS. 2 and 5)

The adapter system 200 also is shown connected to a magnet-mounted external fuel tank level (pinging) sensor 360. The magnet-mounted external fuel tank level (pinging) sensor 360 operates with the adapter device 220 ((and/or the wireless thermostat device 420 in FIG. 5) to remotely determine exactly how much fuel is left in a fuel reservoir or tank. The level (pinging) sensor 360 generates a sound signal (e.g., u/s) at a frequency commonly used in such devices and processes the echo signal returned. Based on the processing, a communication signal may be generated and transmitted to the hand-held control device 180 to alert an owner of a low fuel condition, or to a supplier to automatically order a fuel delivery.

The adapter system 200 also is shown connected to a wireless occupancy proximity camera 370. The wireless occupancy proximity camera 370 is in wireless communication with the adapter device 220 (and/or the wireless thermostat device 420 depicted in FIG. 5) allows the software operational in the adapter device (and or that operational in the hand-held control device or the server) to track the numbers of persons present in the space or zone controlled by the thermostat (i.e., the net in when viewing all those entering and exiting a space or zone) to accurately assess an amount of body heat generated by the persons present. Accurately assessing the amount of body heat sets the stage for the processing that then optimizes the heating/cooling, as will be explained in greater detail below

### Application Program

As mentioned, the technical adapter system 200 includes an application program component for operational in the hand-held control device 180, and an application program component for operation in the adapter device 220. Alternatively, the system may also include an application program component operational in the server 392. The application program component in the hand-held control device 180 controls the adapter device 220, in response to the command signals received from the application program component (operational in the hand-held control device 180), but for the independent operation of the home button 135 and the micro dip switches 218, i.e., R_{c}/R_{H} 218S1, O/B 218S2, Y1 218S3, Y2 218S4, G 218S5, W 218S6, W2 218S7, and T.T 218S8. Hence, the application program component in the hand-held control device 180 includes and operates a feature in the set up mode of operation for occupied and unoccupied conditions. For example, the adapter device 220 recognizes the thermostat's preprogrammed temperature set points, and/or allows a user to input preprogrammed temperature set points (through the hand-held control device 180 and application program component operational therein). The temperature set points in occupied mode has a programmable minimum and maximum operating temperature range, e.g., a maximum of 70 degrees heating and maximum 72 cooling degrees.

### Human Occupancy Energy Efficiency Calculations

An inventive feature is the invention's reliance upon human body heat output, i.e., that each person's body operates like an additional heating system radiator (but with a slower rate of propagation, that for example, a radiator that might be part of the HVAC system. So, the system (e.g., CPU 126 or application program portion operational therein) counts the number of people, calculates their BTU output and adjusts operation based upon the equipment's BTU output rating in view of the BTU output attributable to persons present. Then the system (e.g., the CPU 126 or application program portion operational therein) prefixes the set temperature and stops the HVAC equipment run at a temperature adjusted for the exact percentage calculated, with the expected estimate that human heat provides the offset percentage to satisfy setting. The range of the given adjustments are between the set temperature and cutout temperature (typically 2 degrees below set, can be adjusted).

For example, with the set temperature=72, and cutout temperature is minus 2=70, Range=2. So, if enough people present in the space or volume is equal 15% of the equipment BTU output, then the heating system would be controlled to be shut off at 15% of range below set temp (71.7). The human heat will be realized mostly by individuals standing close to each other. Most of that human convection BTU is absorbed through thermal losses before ever reaching the thermostat. The result is a precise temperature offset based on the number of humans emitting body heat into a given area for each cycle. Cooling involves the inverse calculations for each element of the formula, where the equipment is shut off above the set temp when fewer people are present. The average percentage would be based on total legal occupancy count minus the number of occupied persons.

However, AC would only realize a savings when the room is less occupied, since human body heat works against the cooling; energy savings is typically achieved when this feature is used with heating. Other features: outdoor temperature and cycle rate adjustment is a separate energy savings feature. Additionally, equipment cycle rates will be co-managed and micro-adjusted dynamically, based on outdoor temperature. For accuracy, regional and local weather information is fed to, for example, processor 124 on FIG. 4 via the system's cloud management server. At the cloud, the operating software application program component acquires local temperature information (for example, from sensors or the Internet) for a given adapter device 220 (FIG. 4), in operation at its location. The adapter device processor 126 (FIG. 4) will adjust cycle rates based on industry standards for a given equipment's operating parameters at different outdoor temperatures. Seasonal adjustments will be automatic since daily, outdoor temperature and climate information are being fed to the adapter device processor continuously.

The hand-held control device 180 application program component is designed as a web application and can be accessed via the Internet. The hand-held control device 180 application program component works as a controller. While the application program component in the hand-held control device controls the adapter device 220 remotely, in cooperation with the application program operational in the adapter device 220, the hand-held control device may also be controlled by an application program component operational in the central management system 390, that is, operational in the cloud server 392. The application program component operational in the central management system 390 is programmed to run on major web browsers, with any common Internet device. The user need only log into their account and the application program is automatically downloaded for the session in which it will be utilized.

Once a user has logged out of the application program component operational on the cloud server 392, the application program component is no longer available until the user logs back into their account for another session. The adapter 220 and web-based application program is a convenient design alternative for the consumer, as it eliminates the trouble of downloading and installing a hard-coded application components onto their hand-held control devices. The web-based application also is conveniently available to all the consumer's personal, Internet devices automatically.

### Improves Energy Efficiency of the System Through Cycling

The technical adapter system 200 includes a feature by which an amount of energy required to maintain the set temperature of a space, or multiple spaces, heated and/or cooled by the HVAC system components, is optimized to be a minimum (amount of energy). The technical adapter system 200 does this with improved or optimized cycling operation. The adapter device 220 (i.e., the application program component operational therein) calculates specific frequencies of operation of the HVAC system components during heating and cooling cycles. The cycle rate as used herein is the number of times the HVAC system component(s) is powered on and off per hour combined with the total duration the components remain on, within a given cycle. Energy efficiency is enhanced when the HVAC component power cycles exactly match the rates at which temperature changes, indicated, for example, by sensor 138, and the out-door temperature, determined, for example, via a weather channel for a given area at which the HVAC-controlled space is located. The adapter device 220 controls HVAC system component cycle rates by multiple factors, which are defined by user entry of specific data using a setup program function. The multiple factors include without limitation total cubic foot area of the HVAC-controlled space, proximate minimum and maximum occupancy, capacity output level specifications of the HVAC system, etc.

### Sequence of Installation and Processor Programming of A/C, Gas Warm Air, Heat Pump Wiring Diagram FIG. 3

Basic control wiring diagram of processor 126 (FIG. 3) is programmable to setup and control an A/C with Gas Warm Air Furnace and/or Heat Pump combination systems. Eight control wire conductors are required for this FIG. 3 wiring diagram. Five conductors are required as shown on FIG. 3A without Heat Pump. The adapter device 220 can be installed as an adapter or a single stand-alone controller. FIG. 3 relay bank 122 are relays operated by processor 126 controlling system operational functions. Terminal strip 152 on FIG. 3 of conventional thermostat 150 is re-routed via conductor 154a through harness 242 via conductors 223b, on to corresponding load side of relay bank 122. Each corresponding relay on load side of relay bank 122 on FIG. 3 via conductors 223a through harness 240 via conductors 154b on to corresponding terminals on terminal strip 374 circuit board controller located in the manufacturer's HVAC equipment.

The processor's initial control setup during installation and setup of the adapter device is selected and setup on the application program portion embedded in the CPU 126, where selections are pre-programmed for selecting the correct diagram to adopt and retrofit to existing HVAC control wiring. In an A/C, Gas, Oil, Warm Air, Heat Pump Wiring Diagram (FIG. 3), including wireless adapter device 220, temperature sensor 138 can control the HVAC system, which requires 8 control conductors using R/C, R/H, Y1, G, W1, W2, O and C. With most hydronic heat control systems, the thermostat R/C R/H jumper is removed, then a separate existing 24V transformer is being used, the R/H and W relays controlling the hydronic heating system are isolated. The R/C transformer normally known as the cooling transformer, controls the cooling and heat pump system control circuits only. The (O/B) relay on terminal bank 122 operating reversing valve in the HVAC equipment is connected depending on N/O or N/C type reversing valve as per OEM HVAC manufacture. CPU 126 selection menu is adoptable to operating an A/C, Gas Warm Air, Hydronic Heat, Heat Pump.

CPU 126 presents a selection menu can select and set a control circuit operation of a heat pump system with various media, including electric re-heat to be combined and energize (W2) 2nd stage during defrost cycle, via signal from FIG. 4 current sensor 230. The adapter device 220, on board current sensor 230 (FIG. 4), during the heat pump mode, the reversing valve within the OEM heat pump unit is energized. The O/B relay located on relay bank 218 shown on FIG. 4 energizes the (O) or (B) contacts, sending power to the reversing valve. The current sensor 230 sensing current draw of the reversing valve, signals processor or CPU 126 that the heat pump is in operation. During normal heat pump operation, the processor temperature sensor allows W1, W2 and T.T relays to operate for additional heat when required to satisfy load.

The heat pump integral master controller panel located internally in the OEM heat pump unit controls all heat pump operation. The master control panel sensing a required defrost event causes the reversing valve 326 to de-energize and activates the cooling mode. During the defrost cycle event a loss of de-energized current draw is sensed by the current sensor on O/B relay, signaling the processor to energize a heating element such as a boiler, zone valve, remote or integral OEM electric heating elements 334, 330, 328, 327 on FIG. 4. At the completion of a defrost cycle the adapter 220 returns to normal heating operation.

### Sequence of Installation and Processor Programming of A/C, Gas Warm Air or Boiler Wiring Diagram FIG. 3A)

The wiring diagram depicted in FIG. 3A requires 5 control conductors in parallel with relays 122 terminal strip 374 and terminal strip 152. This circuit can only operate an A/C, gas warm air and boiler system using a single or dual transformer, by adding or removing the jumper between R/C and R/H. During setup the adapter device 220, processor or CPU 126 implements a selection mode that allows the choice of operating a gas warm air heating system powered by a single R/C transformer for both heating or cooling or isolated R/H transformer at terminals R/H and W to control boiler and ancillary heater. Adapter device 220 also has an on board single or dual transform power source selector switch, to direct R/C power to (W) relays operating controls from an R/C single transformer source to energize a gas valve, powered boiler, circulator relay, boiler relay and electric heat elements. Adapter 220 enables toggling of R/C or R/H transformer power on to W terminals 122 when required to use separate sources of control power to terminal strip 347.

### Sequence of Installation and Processor Programming of R/C, R/H, Multiple Transformers for A/C, Heat Pump, Hydronic, Boiler Circuit With Pump Zone Controller on FIG. 4

As shown in FIG. 4, processor or CPU 126 is programmed to enable selection of numerous types of control wiring seniors and combinations of systems and internally modifies a specific point to point printable diagram based on input information of existing HVAC components prior to installation of device 220, such as A/C, Heat Pump, Boiler, Zone Pump control panel, Zone Valves with end switches, also electric (or) hydronic re-heating with multiple fuels including LP gas, Propane, Geothermal, Electric Strip Heaters and other sources of fuel. Relay (R/C R/H) is shown on its normally open position disconnecting power causing the conventional thermostat 150 inoperable to prevent tampering and abuse of HVAC system during HOME button activation, allowing only adapter 220 to operate the system at the preset temperature point. The R/C (R/C)-(R/H) or separate R/H transformer power relay 218S1 with on-board switch 227 DP/DT NO/NC switch is in the (YES) position R/C power connected to the common (center pole) terminal to power W1 relay input to operate (W) relays on relay bank 218 using a single R/C transformer for both heating and cooling.

Constant power is input from R/C relay to terminals Y1, Y2, G and O/B. When the switch 227 is toggled to the (NO) position, power is disconnected from the R/C transformer to the W relay. This circuit allows conventional operation of an R/C transformer to energize a heat pump circuit separate of R/H powered heat circuit, such as boiler, remote heaters, pumps. Current sensor 230 measures by sensing a change of R/C power current draw during heat pump cycle operation of current of the reversing valve during a heat mode. Current sensor signals processor or CPU 126 to energize the defrost reheat control cycle powered independently by the R/H power transformer. 24V power from R/H transformer 324 connects R/H terminal of terminal block 374. R/H conductor from terminal strip 374 through harness 240 powers the R/H contacts on relay 218S1 and continues to the load side of switch 227 (NO) position. In the (NO) position the R/H power is delivered to the input side of W1 relay.

When relay 218S1 is closed, power is simultaneously sent to W2 relay input. The commons (C) conductor legs of transformers 322, 324, compressor contactor, reversing valve 326 are isolated on to (C) terminal strip 374. The zone control internal transformer and existing boiler room transformer 332 common (C) conductor legs are connected to the designated relay (see FIG. 4; 327). Prior to switching relay 328 with integral power transformer connecting to W1 on terminal strip 374 and continuing to the load side of W1 relay 218S6 the R/H contacts of relay 218S1 de-energizes transformer 324 and conductor from common (center post position) of switch 227 to input terminal of W1 and W2 relay located in device 220.

When a boiler T.T relay jumps W1 and W2 load side and relays W1 and W2 open, no power on input side of relays W1/W2, T1/T2 contracts create a complete circuit to control 327 isolated transformer 325 to energize boiler contactor relay 328. The T.T. relay is controlled by the temperature sensor 138 in processor 124 and toggles the start and stop of the boiler based on temperature set points. When retrofitting the wireless adapter 220 into an existing wired boiler room circuit, the existing 24V boiler room transformer 332 powers the R/H terminal on terminal strip 374 and brings power to load side of R/H relay 218S1 and continues power to R/H terminal of the conventional thermostat 150 when R/H contacts are made on relay 218S1 activating operation on the home button. When incorporating an existing boiler room transformer 332 connected with a required isolated (C) common conductor leg, connection from 332 to zone valve and (C) common conductor leg to the common leg of the coil relay of zone valve 330. The processor opens the T.T. relay jump across W1 and W2 prior to allowing the 218S1 relay to close its contacts. Closing relay 218S1 when the W2 relay is energized in a call for heat, the R/H load side of relay 218S1 travels through W2 terminal on terminal strip 374 to T1 terminal of zone relay 330 closing the contacts to power the zone valve actuator, then at the completion of the zone valve travel opening, engages the internal end switch, sending line voltage power to the circulator pump for Hydronic coil or baseboard system.

### Occupancy

As mentioned, occupancy is a factor that the technical adapter system 200 relies upon for maintaining optimal HVAC cycle rates including occupied and unoccupied temperatures for the space, or sub-spaces. As human motion increases or decreases, the adapter device 220 (i.e., the application program component operational therein) determines a closely approximated number of persons present in an area. The net count of persons in the controlled space is determined by the application program component in reliance upon data from conventional devices, such as remote or built-in wireless occupancy proximity camera 370 (FIG. 2, FIG. 4). When the occupancy count changes, the adapter device 220 adjusts the temperature respectively, toward one end of the predetermined temperature set points by adjusting the average cycle rates while keeping temperature within that range.

The capacity control is accomplished by activating multiple stages of cooling or heating and reducing or increasing the cycle rates of the HVAC system, monitoring such changes in several persons in a fixed area, which could affect temperature, the technical adapter system 200 can include a motion sensor(s) electrically or wirelessly connected to the adapter (not expressly shown), positioned at points of entry/exit. The motion sensor (or for example, the proximity camera(s) 370 sense(s) a presence of people and communicates data to the adapter device 220. Preferably, the motion sensors are retro-reflective type photo-sensors mounted by the entrance and exit doors of a space, e.g., a store or building. The adapter device 220 receives this occupancy data and tallies a positive or negative count of persons as they pass by the sensors and walk in and out of an entrance way.

The adapter device 220 uses this occupancy data to calculate the cycle rates for a particular zone, or the entire space covered by the HVAC system. The adapter device learns the temperature patterns of the target area to efficiently adjust the HVAC system output based on the parameters input minimum and maximum during the set-up mode. Human body heat is slow to release and takes more time to reach the thermostat's thermal sensor than typical forced air or convection heat. Based on rough constants that humans output certain amounts of BTU levels of body heat, the cycling control calculation parameters to fine-tune temperature control, predicting the amount of heat to be released into the area controlled by the HVAC system (from the bodies of the persons present), the adapter device 220 (e.g., the application program component operational therein) calculates and adjusts cycle timing to avoid over heating or over cooling.

The adapter device automatically calculates and offsets the heat or a/c settings to account for the additional persons, before their body heat reaches the thermostat sensor. Once the adapter device has determined that human motion has stopped (e.g., detects a near zero persons count), the adapter device will automatically enter an unoccupied mode. The unoccupied mode has its own night-time temperature setting. The adapter device calculates the longest, possible off-time cycle rate in which to minimally satisfy the night-time temperature settings in a predetermined variable scale during setup mode, and the adapter device automatically enters the unoccupied setting. The adapter device monitors temperature and time to properly schedule the optimized preset temperature.

Advanced scheduling features allow the adapter device 220 to enter an energy saving mode during unoccupied hours. While in the energy saving mode, the adapter device may exercise HVAC equipment (i.e., HVAC system components) to test and ensure reliable operations for the entire HVAC system. Diagnostic checks are performed during regular, nighttime equipment cycles, and will only cycle HVAC equipment. If at any time during any mode of operation, the adapter device 220 detects that an HVAC system component has not satisfied the set temperature, or is otherwise not functioning as required, then an email or text message will be dispatched to the user's account/telephone number on file (preferably by the software component operational in the server 392, but also by the software components operational in the hand-held control device 180 or adapter 220). The consumer also can enter any email or text phone number into the display screens provided for that purpose (on the hand-held control device 180) to change the notification address any time they need. In an embodiment, in case the Internet connection is lost, the existing conventional thermostat 150, 250 temporarily takes over control of the HVAC system from the adapter device 220.

Alternatively, the adapter device 220 may rely on data provided to it from optional, wireless occupancy proximity camera 370 (FIG. 2) positioned to capture an image of the entire target area. In this embodiment, the images are taken during operating cycles, and are compared to pre-calibrated images of an empty room within the controlled space, under various lighting conditions. The application program component operational in the adapter device 220 (or the central management system or cloud server 392, as the case may be) processes this image data every few seconds, compares the image data details and computes the number of persons, either present or moving about. The adapter device maintains a running total of people for the target area. So, unlike conventional thermostats 150, 250, the adapter device continuously adjusts the HVAC cycles based on set up of minimum/maximum reset point range of temperature desired during occupied mode. This maintains optimal temperature control by controlling operating time within the desired minimum/maximum setup and maintaining a high degree of efficiency of a heating/cooling/ventilation system.

Using the predetermined target area dimensions and HVAC equipment specifications, the adapter device 220 calculates the optimal amount of time needed to start-up equipment, to have a “set” room temperature, at an exact opening starting time. This feature works in conjunction with regular schedule settings to enhance energy efficiency. The adapter device calculates the most efficient “drop-back” temperature of which to maintain during off-hours. The programmed algorithm operational in the application program component operational in the adapter device 200 (or the central management system cloud server 392 as the case may be) calculates the amount of energy it will take to bring the room area (i.e., controlled space) back to normal (i.e., pre-set) operating temperature, given the currently installed HVAC equipment component's output rates along with the target area dimensions.

The adapter device 220 (i.e., the software component operational therein) “learns” the temperature patterns within the target area and use the averages calculated in view of the patterns to determine the most efficient time/cycle needed for restoring daytime temperature. For example, when heating, if the temperature is kept too low during evenings, then the adapter device or other HVAC system controller will use too much energy at opening time to restore desired temperatures, causing not only an unnecessary energy expenditure but also unnecessary wear and tear on the HVAC equipment components. If the temperature is set too high based on system recovery learned by the adapter device 220 during unoccupied hours, then the HVAC system is simply wasting energy. To address this problem, the adapter device (application program component therein) calculates and finds the optimized temperature to maintain during unoccupied and outdoor temperatures to recover, to occupied periods. Moreover, since the adapter device 220 is an Internet capable device, it can conveniently and regularly download local weather information for the installation target area. The adapter device uses this data to enhance its ability to predict temperature change rates and other factors that could affect the changes of indoor temperature regarding onset, frequency and intensity of outdoor temperature changes.

As described, the hand-held control device 180 connects via the Internet to set and control features of a conventional standard thermostat 150, 250 plus additional features not available with the current “smart” thermostats available on the market. The hand-held control device 180 is therefore capable of controlling an HVAC system component beyond the ordinary “nest” thermostats by providing a multitude of wiring configurations depicted in the figures. The user can trigger a time earlier or later then a normal daily routine memorized by existing self programing thermostats. Simply put, the user can open his/her temperature application (on the hand-held control device 180) and select an earlier or later time of an arrival so that technical adapter system 200 will override the general programed time. The central management server system or owner can change and hold back a system to operate in the event of abuse. So, if he or she is coming back a day earlier or later to a home or business, the user opens the application program and triggers a calendar to adjust the setting, which is presented on the display screen on the hand-held control device 180. Providing the ability to re-set programming realizes an additional energy saving solution.

### Equipment Status

The adapter device 220 (i.e., the software component operational therein) regularly updates its live status to the hand-held control device 180 in real-time. Any change in temperature or equipment/component operation detected within the HVAC system is immediately forwarded from the adapter device 220 to the application program component operating in the hand-held control device 180 as soon as it occurs. If an HVAC equipment component should fail on power-up, then a status of “fail” will soon be displayed instead of IDLE or RUN on the hand-held control device 180 display screen, as the hand-held control device application program component operated by the hand-held control device's on-board computer realizes there is no change in room temperature after sufficient equipment run time.

### Server 392

The adapter device 220 operates as an Internet based, central communications controller and user/device account manager, controlled by the central management system 390. The central management system 390 comprises a server 392 in which a set of instructions comprising an application program implementing system management control is operational. Both the adapter device 220 and the hand-held control device 180 connect to the server 392, as explained above. The server 392 operates as a central communications hub of which both the adapter device 220 and hand-held control device 180 will communicate with each other. The server also maintains all the user and device accounts information associated with each product activation and invoice.

The adapter device 220 also is configured to operate with one or more wireless HVAC (component) interface devices (“interface devices”) 270 (see FIG. 2). The interface devices 270 may be equipped with current sensors to monitor HVAC system component elements, such as compressor motors, condenser motors and blower motors. The interface devices 270 are arranged at the location of HVAC system components, such as compressors, condensers, blowers, etc., without limitation. The interface devices 270 include sensors that sense amperage and other equipment operational parameters, and then send signals communicating his data to the adapter device 220 and/or the energy management system 390 at the server 392 for control of a complete HVAC system, via the hand-held control device 180.

The interface 270 also control low ambient operation of the HVAC system component at which each may be positioned. In the event of a loss of Internet service, the HVAC system immediately continues to operate via hard wire connection and conversely when hard wire connection. Also, an alternate transformer may be built into the interface 270 if low voltage power is lost. Typical HVAC units can be connected by a panel populated with multiple interfaces 270 in large facilities (not shown).

### Wireless Thermostat System

FIG. 5 depicts a wireless thermostat system 400 of the invention. Wireless thermostat system 400 comprises at a minimum a wireless thermostat device 420 (referred to commercially as the COBRA™ wireless thermostat system) and a hand-held control device 180. The wireless thermostat system 400 preferably additionally includes a central management system 390. Central management system 390 comprises a central management server 392. Like the adapter system 200 shown in FIGS. 2, 3, 3A, the wireless thermostat system 400 operates to control several HVAC systems and components. In an embodiment, the wireless thermostat system is configured to communicate with a tech supporter device 120, one or more wireless HVAC interfaces 270 (installed at HVAC system components), a wireless police lock and smoke and fire sensor system 300, a package HVAC a/c condensing unit heat pump 320, a wireless GPS unit locator 340 (installed at HVAC system components), a magnet mounted external fuel tank level (pinging) sensor system 360 (installed in a fuel tank as the case may be), a wireless occupancy proximity camera 370, and the central management system 390, via hand-held control device 180.

The wireless GPS unit locator 340 (FIG. 2), wireless sender/receiver wireless GPS unit locator device APP. is incorporated with or without device item numbers 120, 180, 220, 270, 300, 320, 360 on FIG. 2. The wireless GPS unit locator 340 improves and simplifies the process of locating HVAC units in concealed spaces, e.g., drop ceilings, mechanical rooms, roof tops of hospitals, high rise office buildings and such. The wireless GPS unit locator 340 reduces time and effort in locating HVAC equipment, liquid fuel tanks and other concealed equipment in critical locations by not having to remove ceiling tiles, access doors, access, fire walls causing unnecessary damage and repair in these areas. Each HVAC unit is equipped with a signaling device that communicates with the specific temperature controller operating that HVAC unit location. Each sending device 340 and each corresponding temperature controller are twined together having the exact communication I.D. serial numbers. At initial setup of the locator and temperature control a link is created either by USB, QR bar code, scanner or other methods. At completion of linking devices the sending unit is installed into the HVAC unit and powered.

A battery backup within the device will continue in the event of a power failure. Completion of each linking of the devices creates a GPS path from the temperature controller to the HVAC unit as the technician follows the path from point A to point B. The GPS path or paths are stored in a memory, for example, in the server or attached to the server. For that matter, the wireless thermostat system may include a central BMS system (central Building Management System), with memory storage for storing the created GPS paths or other information. For that matter, both the wireless thermostat system and the central BMS system can create a printable GPS map that map locations of equipment for future use.

The wireless liquid fuel level (pinging) sensor 360 (FIG. 2) measures liquid level content of fuel within a fuel storage tank. The device is mounted magnetically on to the exterior steel storage fuel tank. The devices' ability to ping and receive a signal of a change in sound caused by interior liquid volume. As the volume reaches below the predetermined level of where the pinging device is positioned and a change in sound infrequence energizes the device to deliver an electronic message over to the BMS management system, to effectuate an improved fuel delivery system beyond today's average degree days method of fuel delivery calculations.

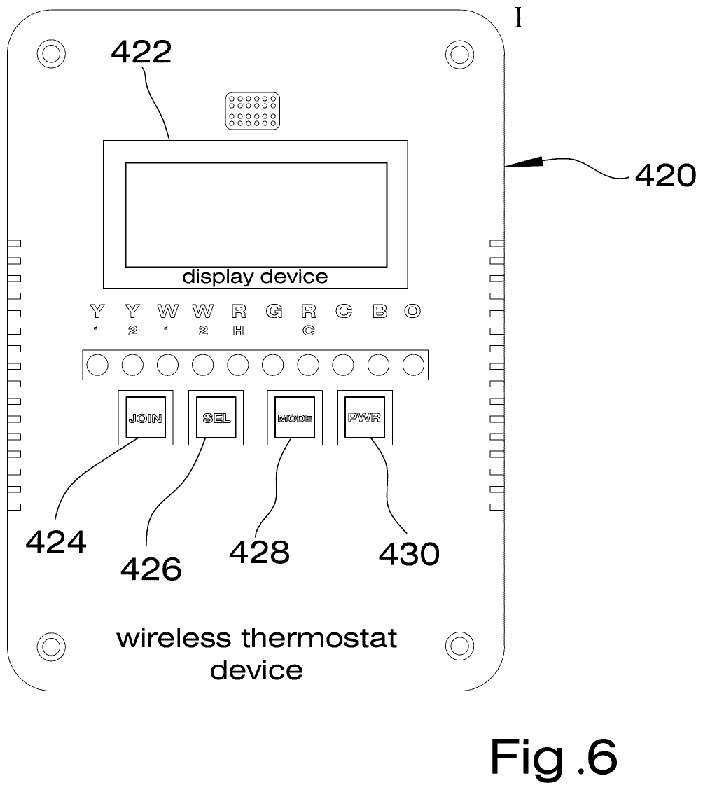

The wireless thermostat device 420 includes a display device 422. The wireless thermostat device may include an input device, such as a keyboard (not shown), or may alternatively operate a virtual keyboard, or other virtual input device, to allow a user to input data, such as command, directly at the device 420. Of course, the system 400 also allows a user to input commands to the wireless thermostat device 420 via the hand-held control device 180, as explained in detail above. The thermostat device also includes several hard wired activation buttons, such as join 424, select (sel) 426, mode 428 and power (PWR) 430. These are highlighted in the exemplary embodiment of the wireless thermostat device depicted in detail in FIG. 6.

Please note that the wireless thermostat system 400, and wireless thermostat device 420, operate as do the adapter system 200, and adapter device 220, except that the wireless thermostat device includes a display device 422 and other elements, and obviates a need for a conventional thermostat 150. Preferably, wireless thermostat devices are used in new constructions, or to totally replace conventional thermostats.

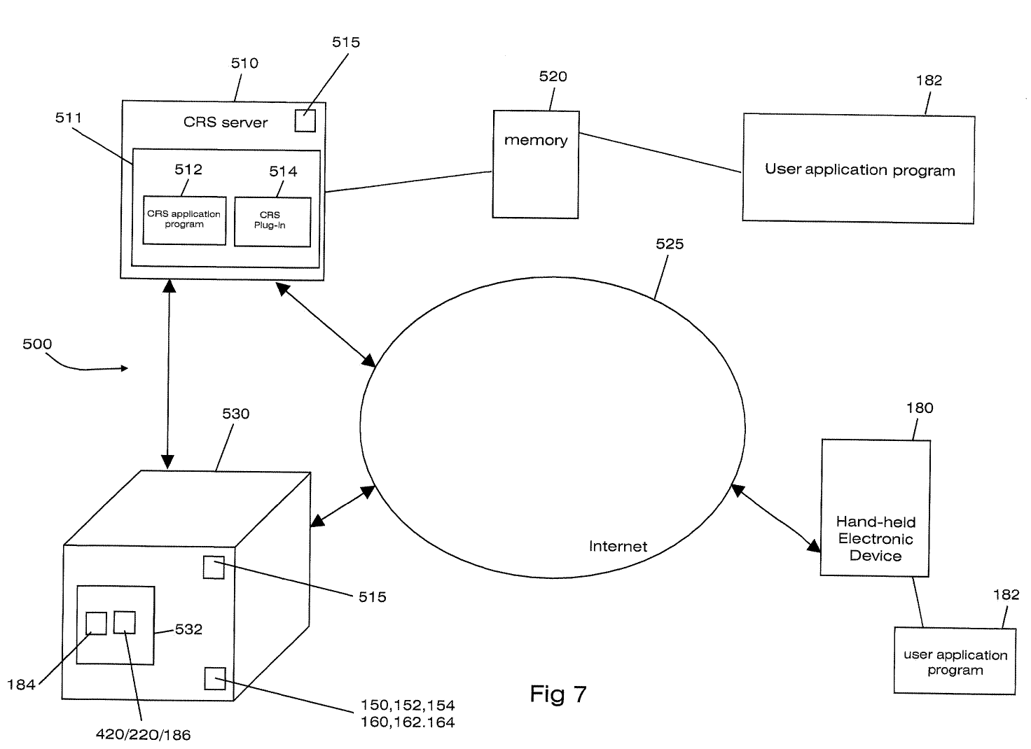

In addition, the invention provides a central reservation system (CRS) configured to reserve an organization's rooms and remotely control HVAC components and offset temperatures in the organization's rooms via the CRS on a programmed, variable offset temperature scale to optimize energy efficiency of the organization's rooms. This embodiment is shown in one form in FIG. 7.

The CRS 500 comprises a CRS server 510 operating a CRS application program 512 that manages reservations of the organization's rooms and operating a CRS plugin 514 that operates with the CRS application program and conditions data to effect remote control of the HVAC components and offset temperatures in reserved rooms optimizing energy efficiency of HVAC components servicing the rooms (unless overridden), according to the inventive principles. Alternatively, the CRS server 510 may operate a CRS application program that performs conventional central reservation functions and the CRS plugin functions. The CRS plugin 514 and CRS application program 512 implement the inventive energy management system protocols. The CRS application program 512 and the CRS plugin 514 each comprise computer readable instructions that may be stored in a memory or other non-transient computer readable medium such a USB storage device or cloud storage modality) directly accessible to the server 510 and (server processor), for example, in a server memory 511 or indirectly stored in a memory 520 outside of but connected to the server 510. “CRS server” (510) may be used herein to refer to the server operating the CRS application program 512 together with the CRS plugin 514.

The CRS server 510 preferably is located in an organization's structure 530, for example, comprising the rooms or apartments within a building structure such as a hotel or cooperative apartments to be controlled for energy efficiency but may also be located at a separate location from the structure 530. The separately located organization structure 530 would then require a router 515 (as does the server 510) to connect devices therein to the connect to the CRS server via the Internet 525. The CRS 500 also includes a wireless thermostat device 420 or wireless thermostat adapter 220 arranged in each of the organization's rooms (for example, a room 532 in organization structure 530). The wireless thermostat devices/adapters are in communication with the CRS server 510 and the HVAC components (150, 152, 154, 160, 162, 164). Such communication can be hard-wired, or wireless, depending on the server location and location of the HVAC components. For example, the CRS server, wireless thermostat adapters/devices and HVAC components preferably have Bluetooth capability to communicate wirelessly directly, they also can have Wi-Fi capability to communication through the Internet in reliance upon routers as required.

The CRS 500 can also include a user application program 182, making copies of same available for download, for example, from a memory storage such as 520 or a memory arranged in or connected to the CRS server 510, to a user hand-held electronic device 180. The user application program 180 may be downloaded at a time that the user makes a reservation or checks in to one of the organization's reserved rooms. The user application program, among other things, enables the user to communicate directly with the CRS server (i.e., and the CRS application program and/or CRS plugin operating therein) 510 and, therefore, the thermostat device 420 or adapter 220 to control the HVAC components that service and thereby control the temperature and energy expended in the reserved room (e.g., 532). Alternatively, upon downloading the user application program to the user hand-held electronic device at check-in, the user application program enables communication between the user hand-held electronic device and the wireless thermostat and/or wireless adapter operating in the reserved room (for example, through a router 515 in the structure 530 in communication with the wireless adapters/devices 220/420). For that matter, and while not shown, the wireless adapters/devices 220/420).may communicate wirelessly to a router connected to a building management server in Internet communication with the CRS server 510.

The central reservation system (CRS) 500 includes at least one sensor 184 arranged in each of the organization's rooms 532 in communication with the thermostat device 420 or thermostat adapter 220 (and CRS server) for detecting conditions in the organization's rooms. The sensors 184 can be part of the wireless adapters/devices 220/420) or merely in communication with same (for example, connected wirelessly using Bluetooth) in order that the sensor data (the detected conditions data) are communicated to the CRS server 510 (and if necessary to the user application program 182 in device 180)). Based on such data, the CRS server 510 and CRS program 512 and CRS plugin operational therein) can process the detected data and take some action in furtherance of the intended energy efficiency), for example, by overriding current set data for the respective organization's room or rooms. For that matter, the user (user device 180), via the user application program 182 downloaded thereto also can override current set data for the checked-in organization room.

In addition to processing the detected conditions data received from the at least one sensor 184 via the wireless thermostat device 420 or adapter 220 in each of the organization's rooms 532, such processing can also include processing data available from outside data sources, including up to date weather data, fluctuating energy availabilities, and user data input via a hand-held electronic device 180 in which the user application program 182 is operational to effectively control the wireless thermostat device or adapter and, thereby the HVAC components to optimize HVAC cycles, average hourly time cycling periods and HVAC component run times during occupied and unoccupied time periods in the reserved rooms. Please note that the CRS server 510 may periodically control the HVAC components (150,152, 154, 160, 162, 164), wireless thermostat device 220 or adapter 420 and/or the at least one sensor 184 to effect a maintenance exercise of one or more system components.

Upon completion of the periodic maintenance exercise, the CRS server 510 processes any detected maintenance exercise data and may send a communication alerting personnel of the maintenance exercise results. The CRS server 510 relies upon a memory store, such as memory store 520 to store detected conditions data, data from an outside data source, wireless thermostat device 420 or adapter 220 data and/or user input data, as well as processing results. This the data also may be communicated in the form of generated reports. During intended operation, the CRS server (in reliance upon the application program and plugin operating therewith) may control the HVAC components and the wireless thermostat device or adapter in each of the organizations rooms to effect a first environmental room state reflecting non-reservation, a second environmental state reflecting a time between reservation and check-in, a third environmental state reflecting a time between user check-in and check-out where the user is present in the reserved room and a fourth environmental state reflecting a time between user check-in and check-out during which the user leaves the room temporarily. The user (user device 180) may use the user application program 182 to override the temperature setting determined and controlled by the CRS server operation during the third and/or fourth environmental states. For that matter, the CRS server may be substituted by a building management server (BMS) with a BMS (application program) plugin, which is functionally equivalent to the CRS plugin. That is, the BMS plugin provides the capability of the inventive energy management system processes and protocols.

Users may make reservations through the CRS server 510 (for example, by phone to an agent or via a CRS server 510 website), or through another reservation system in connection with the CRS server (an independent room reservation service provider). For that matter, the central reservation system (CRS) application program 512, with or without reliance upon the CRS plugin 514, may communicate with the user application program 182 on a user device, where the user application program is downloaded and operational in a user's hand-held electronic device 180, and vice versa.

In the invention, the conditions data, as described above, also can include a closely approximated number of persons present or absent in each of the organization's rooms. The at least one sensor 184 in each of those rooms can include a motion sensor (not shown in FIG. 7) that generates and transmits a signal that is processed by the CRS server 510 and again. Based on the processing results of this sensor data, the CRS server can define the settings defining one or more the first, the second, the third and the fourth environmental states (where the latter two states may be overridden by the user using the user application program). An example of this could occur when a scheduled worker or a non-scheduled worker (housekeeping, repairs, room maintenance, etc.) is detected by the motion sensor temporarily, for example, in the first or second environmental states, or in the fourth environmental state where the user has temporarily left the room.

Please note that organization as used herein includes but is not limited to juridical entities, corporations, partnerships, LLCs, individuals, businesses, DBAs, rental properties, schools, hospitals, universities, cruise ships. Organization rooms as used herein includes but are not limited to hotel rooms, motel rooms, offices, conference rooms, apartments, compartments, cubicles, time shares, and vacation home rentals. Preferably, the organization includes an energy center that operates based on an estimated aggregate load on the energy center reflecting a required energy cost to maintain all the organizations reserved rooms and may modify a capacity for said estimated aggregate load if an actual aggregate load changes at least a set minimum amount. The CRS system detects a change in the aggregate energy load relative the instant actual energy load, and adjusts the room temperatures, for example, by increasing capacity to meet the changed requirements. Also, the central reservation system (CRS), which implements the inventive energy management processes and protocols, can automatically override a particular reserved room's current thermostat or adapter settings to adjust to optimize HVAC cycles, hourly and system component run times during occupied and unoccupied time periods for each said reserved room for energy efficiency, as explained above.

As already described in some detail. The central reservation system (CRS) 500 monitors the reserved rooms in reliance upon the CRS server 510 and wireless thermostat adapter 220 or device 420 to implement the inventive energy management processes and protocols in an organization's respective rooms during occupied, unoccupied, pre-set exercise periods. Preferably, the CRS 500 generates and sends an alert in response to detection of a temperature or defective HVAC component in a room (for example, a packaged terminal air conditioner (PTAC), that is set for a temperature that is too high or too low) in view of preferred temperatures found in the stored data. In the invention, users reserving rooms are recognized by the CRS server 510 in reliance upon user data stored and maintained by the CRS server and the CRS server application program and CRS plugin that implement the inventive process and protocols. For that matter, the organization pays a monthly subscription fee to utilize the CRS system. The monthly subscription fee may be based on a number of wireless thermostats or adapters operated by the organization, or the number of organization rooms (go green)

In one embodiment, the wireless thermostat device 420 and the wireless thermostat adapter 220 can include GPS capability 186 and are identified by respective serial numbers. The CRS system 510 identifies each organization room 532 with each wireless thermostat device 420 or wireless thermostat adapter 220 located therein, by serial number, stores the serial number(s) associated with the respective room numbers and any other pertinent information, such as other room information. The CRS server can “ping” any of the wireless thermostat devices or wireless thermostat adapters to return the GPS location of same and compares the actual GPS location (as memory stored) and determines if they are different. If they are at different locations, he CRS server 510 generates and sends a notice to the registered owner of the wireless thermostat device/adapter, indicating that the actual and stored GPS locations are different. For example, where the organization is a high-rise hotel with many rooms, including many floors, the CRS system would only utilize the exact stored address and IP address to calculate how many wireless thermostats or adapters are deployed in the high-rise hotel. This example also would apply to a single-level hotel or motel.

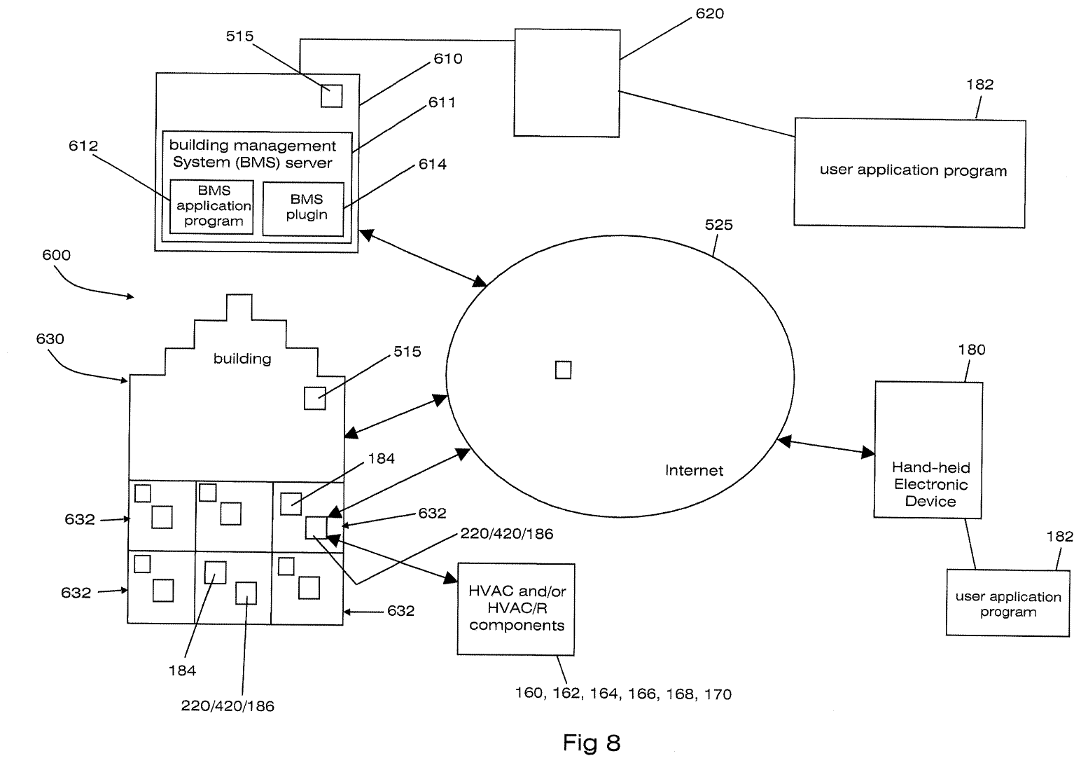

In an alternative embodiment, the invention provides a building management system (BMS) 600 that provides conventional building management services as well as the inventive processes and protocol for remotely controlling HVAC and/or HVAC/R components to offset temperature in a space or volume (e.g., rooms or apartments within a building structure) to optimize energy efficiency of the HVAC components. The BMS 600 is shown in FIG. 8 to include a BMS server 610 operating a BMS application program 612 and a BMS plugin 614, enabling the BMS server to perform building management functions and the aforementioned inventive processes and protocol. Alternatively, the BMS server 600 could be programmed with code that implements both the building management functions and the BMS plugin functions.

The BMS application program 612 and the BMS plugin 614 each comprise computer readable instructions that may be stored in a memory directly accessible to the server 610 and (server processor), for example, in a server memory 611 or indirectly stored in a memory 620 outside of but connected to the server 610. “BMS server” (610) may be used herein to refer to the server operating the CRS application program 612 together with the CRS plugin 614.

The BMS server 610 preferably is located in an organization's structure or building 630 comprising the rooms or apartments 632 with in the building structure that are to be controlled for energy efficiency but may also be located at a separate location from the structure 630. The separately located organization structure 630 would then require a router 515 (as does the server 510) to connect devices therein to the BMS server via the Internet 525. The BMS 600 also includes a wireless thermostat device 420 or wireless thermostat adapter 220 arranged in each of the organization's rooms (532 in organization structure 630). The wireless thermostat devices/adapters are in communication with the BMS server 610 and the HVAC components (160, 162, 164, 166, 168, 170). Such communication can be hard-wired, or wireless, depending on the server location and location of the HVAC components. For example, the BMS server, wireless thermostat adapters/devices and HVAC components preferably have Bluetooth capability to communicate wirelessly directly, they also can have Wi-Fi capability to communication through the Internet in reliance upon routers as required.

The BMS 600 can also include a user application program 182, making copies of same available for download, for example, from a memory storage such as 620 or a memory arranged in or connected to the BMS server 610, to a user hand-held electronic device 180. The user application program 180 may be downloaded at a time that the user makes a reservation or checks in to one of the organization's reserved rooms. The user application program, among other things, enables the user to communicate directly with the BMS server 610 (i.e., and the BMS application program 612 and/or BMS plugin 614 operating therein) and, therefore, the thermostat device 420 or adapter 220 to control the HVAC components that service and thereby control the temperature and energy expended in the reserved room 532. Alternatively, upon downloading the user application program to the user hand-held electronic device at check-in, the user application program enables communication between the user hand-held electronic device and the wireless thermostat and/or wireless adapter operating in the reserved room (for example, through a router 515 in the structure 630 in communication with the wireless adapters/devices 220/420). For that matter, and while not shown, the wireless adapters/devices 220/420).may communicate wirelessly to a router connected to a building management server in Internet communication with the BMS server 610.

The building management system (BMS) 600 includes at least one sensor 184 arranged in each of the organization's rooms 632 in communication with the thermostat device 420 or thermostat adapter 220 (and BMS server) for detecting conditions in the organization's rooms. The sensors 184 can be part of the wireless adapters/devices 220/420) or merely in communication with same (for example, connected wirelessly using Bluetooth) in order that the sensor data (the detected conditions data) are communicated to the BMS server 610 (and if necessary to the user application program 182 in device 180). Based on such data, the BMS server 610 and BMS program 612 and BMS plugin 614 operational therein) can process the detected data and take some action in furtherance of the intended energy efficiency), for example, by overriding current set data for the respective organization's room or rooms. For that matter, the user (user device 180), via the user application program 182 downloaded thereto also can override current set data for the checked-in organization room.

In addition to processing the detected conditions data received from the at least one sensor 184 via the wireless thermostat device 420 or adapter 220 in each of the organization's rooms 632, such processing can also include processing data available from outside data sources, including up to date weather data, fluctuating energy availabilities, and user data input via a hand-held electronic device 180 in which the user application program 182 is operational to effectively control the wireless thermostat device or adapter and, thereby the HVAC components to optimize HVAC cycles, average hourly time cycling periods and HVAC component run times during occupied and unoccupied time periods in the reserved rooms. Please note that the BMS server 510 may periodically control the HVAC components (160, 162, 164, 166, 168, 170), wireless thermostat device 220 or adapter 420 and/or the at least one sensor 184 to effect a maintenance exercise of one or more system components.

Upon completion of the periodic maintenance exercise, the BMS server 610 processes any detected maintenance exercise data and may send a communication alerting personnel of the maintenance exercise results. The BMS server 610 relies upon a memory store, such as memory store 620 to store detected conditions data, data from an outside data source, wireless thermostat device 420 or adapter 220 data and/or user input data, as well as processing results. This may be communicated in the form of generated reports. During intended operation, the BMS server (in reliance upon the application program and plugin operating therein) may control the HVAC components and the wireless thermostat or adapter in each of the organizations rooms 632 to a first environmental room state reflecting non-reservation, a second environmental state reflecting a time between reservation and check-in, a third environmental state reflecting a time between user check-in and check-out and during which the user leaves the room temporarily and a fourth environmental state reflecting a time in which the user is present in the reserved room (for example, between the time of actual check-in to the room until the that the user' checks out). The user (user device 180) may use the user application program 182 to override the third and/or fourth environmental states. For that matter, the BMS server 610 may be substituted by a building management server (BMS) with a BMS application program plugin and the BMS plugin that provides the capability of the inventive energy management system protocols. In this case the BMS could operate as does the BMS 510.

Users may implement building control functions through the BMS server 610. A reservation system (not shown in FIG. 8) may be included at the location of the BMS server 610 or building 630 or connected to the BMS server 610. The BMS server 610 is programmed to interaction with a reservation system. In the invention, the conditions data, as described above, also can include a closely approximated number of persons present or absent in each of the organization's rooms. The at least one sensor 184 in those rooms can include a motion sensor (not shown in FIG. 8) that generates and transmits a signal that is processed by the BMS server 610 and again, based on the processing results, the BMS server could override settings defining one or more the first, the second, the third and the fourth environmental states. An example of this could occur when a scheduled worker or a non-scheduled worker is detected by the motion sensor temporarily while the room is in the first or second environmental states to allow for services in the room including housekeeping, repairs, room maintenance, etc.

The wireless thermostat device 420 and/or the wireless thermostat adapter 220 includes GPS capability and are identified by respective serial numbers. The BMS identifies each location during set-up at which each wireless thermostat device or wireless thermostat adapter are installed, at a location, identified by serial number, stored. with serial number with an identify of the wireless thermostat device or wireless thermostat adapter associated therewith, and the installed location defined by its GPS coordinates. Once installed at a location, the BMS pings one or more wireless thermostat devices or wireless thermostat adapters during operation, which causes the wireless thermostat device or adapter to return its GPS location and compares its actual GPS location during the set-up mode, stores GPS location and determines if they are different. If they are different, the BMS preferably generates and sends a notice to the registered owner of the wireless thermostat device or wireless thermostat adapter informing the owner that the wireless thermostat or wireless adapter are not in the GPS location it was registered for use.

In an embodiment, the invention provides a building management system (BMS) configured to manage a structure associated with an organization and organization rooms arranged within the structure, remotely control HVAC components arranged to service the rooms by controlling offset temperatures in the rooms on a programmed, variable offset temperature scale. The intended benefit of the BMS is to optimize energy efficiency of the HVAC components according to energy management protocols, and to minimize impact of startup surging by a significant number of HVAC components on a local power grid supplying the building and/or HVAC components. A startup current draw profile of HVAC components can change over time, for example, requiring an increasing surge current and/or an increasing surge current period. It is the surge current amplitudes and/or surge current time periods that can be controlled by the invention to minimize the effect of startup current surging on the power grid. This is particularly important where large buildings with many rooms or spaces with separate HVAC components that are tasked with maintaining environments in the respective rooms or spaces. Under these circumstances, multiples of HVAC might otherwise be compelled to startup at the same time, overburdening the local power grid supplying the multiple HVAC components.

The BMS has a BMS server that operates a BMS application program and a BMS server plugin that co-operates with the BMS application program to control room temperatures by controlling the HVAC components based on conditions data and offset temperatures detected in the rooms according to the energy management protocols. A thermostat device or thermostat adapter connects to the BMS server and to the HVAC components and includes an operational thermostat application program to communicate with the BMS application program and thereby control the temperature and HVAC components to optimize energy efficiency of the HVAC components.

A user application program is downloaded to a user's hand-held electronic device to enable the user connect to the BMS server and/or the BMS application program. At least one sensor is arranged in each of the organization's rooms in communication with the thermostat device (or a thermostat adapter device) to detect conditions in the rooms and provide detected conditions data to the BMS server for processing.

The thermostat application program component or the BMS application program/plugin processes the conditions data, data available from an outside data source, including up to date weather data, sensor and/or user data to manage and adjust to optimize HVAC cycles, average hourly time cycling periods, HVAC surge current data, either stored or realized in real time through the Internet and system component run times during occupied and unoccupied time periods. The thermostat devices or thermostat adapters preferably are wireless (but may be wired), include GPS capability, are identified by respective serial numbers or the like identifying indicia, all rooms have a fixed GPS location. The rooms and thermostat devices or adapters room locations and serial numbers are memory stored and the BMS server is programmed to ping one or more wireless thermostat devices or wireless thermostat adapters to return a GPS location of the devices or adapters and compare the actual GPS locations with the stored GPS locations and determine if they are different for security purposes.

Preferably, the BMS server is located at a different location than the building, in which cases the building likely includes a building server. The BMS server is in communication with the building server. The BMS server generates and sends a notice to the registered owner of the wireless thermostat device or wireless thermostat adapter, and/or the building server, in an event in which the GPS locations are determined by the BMS application program and/or the user application to be different.

In another embodiment, the BMS server and/or BMS application program include operating capability of controlling power used by HVAC motors. Through use of the wireless (or wired) thermostat devices or adapters and an AI based system that is trained to find and provide accurate cycle data reflecting optimal re-start time period rates during HVAC motor start-up to reduce the triple amperage surge that typically occurs during HVAC motor starting. This problem of over current is particularly acute where multiple BMS systems that might draw triple amperage surges for every HVAC motor started in local specific utilities power grid not only waste energy needlessly, but such surges could affect other power grid customers. The BMS application program can provide HVAC-start-up solutions that might include staggering or offsetting startup of individual HVAC components, or groups of HVAC components based on the accurate cycle data for such HVAC components.

The thermostats update to the AI system, which accesses HVAC component cycling and operating data and presents it for processing by the BMS application program/BMS continuously. The AI system can learn statistical power usage from the HVAC component operating and cycling patterns, comparing run times of each HVAC component in a fixed, electrical energy grid, or a plurality of specific energy grids. By doing so, the BMS system (including the BMS application program) can recognize (alternatively, the AI system may recognize) the operating cycle time of each identified HVAC component to reach and satisfy set points (as well as the current surging and surging time period and stagger or otherwise set off the start times in view of same).

The BMS system/BMS application program uses the grid-based statistical data found on the Internet or captured by an AI system to reach a desired/set room temperature set point in the least amount of time. The BMS system/BMS application program may delay (i.e., stagger) the next call cycle of HVAC components that proved to run a shorter cycles time to meet the temperature set point.

Systems that need to run longer to reach a desired set point will have more available power saved by the more efficient systems on the same local power grid. For example, a building with many HVAC components, the AI system analyzes which HVAC components are running well and which HVAC components are struggling to satisfy a load and hold back the well-operating component to balance the energy required to operate the entire building's power consumption (the aggregate power). All operating data of each serial number is imputed onto the server from each thermostat; the operating data are then delivered to the AI system for storage; The operating data and data gathered is processed to determine which HVAC components are running optimally on each specific power grid.

The AI system prevents the possibility that all of the HVAC components connected to the inventive thermostat to start a the same time—this cuts surging during start-up. Also, the AI system selects the most optimum system thermostats run time and increases cycle restart of those systems that run optimally, thereby reducing the power surge effect on the grid. And while the inventive process and system can be controlled by temperature, measured power also can be used as a metric to correlate (or impute) the cost of power of a utility in the area in which the BMS system (and HVAC systems) are located.

The AI system communicates continuously with each HVAC system operating time history in all weather conditions, and then stores that information to compare with similar weather conditions and with or without knowing (standard) occupancy (square feet of space, e.g., hotel rooms during occupied or unoccupied periods).

As will be evident to persons skilled in the art, the foregoing detailed description and figures are presented as examples of the invention, and that variations are contemplated that do not depart from the fair scope of the teachings and descriptions set forth in this disclosure. The foregoing is not intended to limit what has been invented, except to the extent that the following claims so limit that.

What is claimed is:

1. A building management system (BMS) for managing environments in each room of a plurality of rooms within one or more buildings that are environmentally controlled by separate, remotely controllable HVAC components arranged to service said each room of the plurality of rooms, including controlling offset temperatures in each said room on a programmed, variable offset temperature scale to optimize energy efficiency of the HVAC components according to energy management protocols, including controlling times in which the HVAC components startup, sequentially and/or in parallel, to minimize or otherwise limit electrical current surging to effect said HVAC-component startup, the BMS comprising:
a BMS server operating a BMS application program and a BMS server plugin to set an operating temperature in each room of the plurality of rooms based on conditions data and for controlling the HVAC components to realize the set operating temperatures according to the energy management protocols to minimize electrical current surging at HVAC-component startup;
a thermostat device arranged in each of the plurality of rooms that connects to the BMS server and to the HVAC components, and that includes a processor that operates a thermostat application program enabling the BMS application program to control power driving the HVAC components to optimize energy efficiency and minimize electrical current surging during HVAC-component startup, while maintaining the energy management protocols;
means for users controlling the BMS application program; and
at least one sensor arranged in each room of the plurality of rooms in electrical or electronic communication with the thermostat device to detect environmental conditions in the rooms and provide detected conditions data to the BMS application program for processing;
where the BMS application program also processes available data concerning surge timing at startup for any of the HVAC components called upon to startup.

2. The building management system (BMS) according to claim 1, wherein the means for controlling the BMS application program comprises a user application program, operational in a user electronic device.

3. The building management system (BMS) according to claim 1, wherein the one or more building comprise any of the group consisting of private homes and condominium complexes. Cooperatives, business structures, hotels, motels, commercial buildings, industrial buildings, and schools.

4. The building management system (BMS) of claim 1, wherein the thermostat application program component or the BMS plugin processes the conditions data, data available from an outside data source, including up to date weather data, sensor and/or user data to manage, electrical grid data, and current surge data for the HVAC components controlled to startup and based thereon, to adjust to optimize HVAC cycles, startup timing of each HVAC component, average hourly time cycling periods, and system component run times during occupied and unoccupied time periods in each of the rooms.

5. The building management system (BMS) of claim 4, wherein the thermostat device is wireless, includes GPS capability, is identified by a serial number, wherein each room of the plurality of rooms has a fixed GPS location, wherein the BMS server is programmed to ping each wireless thermostat device to return a GPS location of the wireless thermostat device and to compare actual GPS locations with the fixed GPS locations and determine if they are different.

6. The building management system (BMS) of claim 4, wherein the BMS server and/or BMS application program include operating capability of controlling power used by the HVAC components and wherein the BMS server includes an artificial intelligence (AI) based system trained to find and provide accurate cycle data reflecting optimal re-start time period rates, reflecting surging current needs for the HVAC-startup components and utilizing said data to coordinate startup of multiple HVAC components to reduce amperage surging of an electrical power generating and distribution system supplying the BMS system with the startup currents for the HVAC components.

7. The building management system (BMS) of claim 6, wherein the artificial intelligence (AI) system accesses HVAC system cycle data, surging current profiles and other operating data for the HVAC components and presents the accessed HVAC system cycle data and surging current profiles for processing by the BMS application program.

8. The building management system (BMS) of claim 7, wherein the artificial intelligence (AI) system learns statistical power usage from the HVAC component operating profiles, HVAC component cycling profiles and cycling, and wherein the BMS compares run time and surging current time durations of each HVAC component when starting up in the electrical power generating and distribution system supplying the BMS-controlled HVAC components, or in a plurality of electrical power generating and distribution systems, and staggers startup of at least one of the HVAC components to minimize energy surging at startup to avoid electrical power surging in the electrical power generating and distribution system, to limit electrical current surging in a power generating and distribution system powering the HVAC components.

9. The building management system (BMS) of claim 8, wherein the sliding scale is based on the most efficient detected to startup and reach temperature set points in a shortest amount of time to least efficient HVAC components that are detected to startup and reach temperature setpoints in a longest time, or the plurality of HVAC components.

10. The building management system (BMS) of claim 8, wherein the BMS system relies upon the operating cycle time of each BMS-controlled HVAC components operating as a wide area network to reach and satisfy predetermined temperature set points in each of the rooms of the plurality of rooms and to minimize surging in the electrical power generating and distribution system supplying the BMS system.

11. The building management system (BMS) of claim 8, wherein the AI system selects optimum system thermostats run time by increasing cycle time holding back cycle restart on the sliding scale of those HVAC components that run optimally, thereby reducing a power drain by inefficient HVAC components.

12. The building management system (BMS) of claim 11, wherein the BMS system communicates with and controls the wireless thermostat devices and at least one sensor arranged in the rooms to manage and adjust average hourly HVAC cycles, and HVAC component run times during occupied and unoccupied time periods for each of reserved rooms, of the plurality of rooms, in an effort to minimize surging.

13. The building management system (BMS) of claim 12, wherein the BMS system monitors the reserved rooms including the HVAC component(s) associated with reach of the reserved rooms in reliance upon the thermostat device and sensors and generates and sends an alert in response to detection of a temperature that is too high or too low in view of the stored data, in an effort to limit voltage drops and surging.

14. The building management system (BMS) of claim 13, wherein a startup time of HVAC components that require a substantial amount of current at startup, and a longer application of said substantial amount of current at startup, is postponed at least 10 seconds.

13. An electrical power generating and electrical power delivery system in a form of a plurality of local electrical power substations, the system configured to compensate for power surging in the substations, the system comprising:
a processor; and
a memory;
wherein the memory includes computer readable instructions that are processed to implement monitoring for power surging in the substations;
wherein if power surges in one substation, the processor compels one of the other substations to make current available to compensate for at least part of the detected current surging.

16. The electrical power generating and electrical power delivery system of claim 15, wherein the substations each supply commercial users, including commercial buildings managed by building management systems.

17. The electrical power generating and electrical power delivery system of claim 16, wherein the building management systems (BMS) manage environments comprising locations at which separate, remotely controllable HVAC components are located, the HVAC component arranged to control temperature conditions in each room of a plurality of rooms within one or more buildings, including controlling offset temperatures in each of the locations on a programmed, variable offset temperature scale to optimize energy efficiency of the HVAC components according to energy management protocols, including controlling times in which the HVAC components startup, sequentially and/or in parallel, to minimize or otherwise limit electrical current surging to effect said HVAC component startup in any substation, the BMS comprising:
a BMS server operating a BMS application program and a BMS server plugin to set an operating temperature in each of the HVAC component locations based on conditions data and for controlling the HVAC components to realize the set operating temperatures according to the energy management protocols to minimize electrical current surging at HVAC-component startup;
a thermostat device arranged in each of the locations of the HVAC components that connects to the BMS server and to the HVAC components, and that includes a processor that operates a thermostat application program enabling the BMS application program to control power driving the HVAC components to optimize energy efficiency and minimize electrical current surging at HVAC-component startup, while maintaining the energy management protocols;
means for users controlling the BMS application program; and
at least one sensor arranged in each of the plurality of rooms and in each of the plurality of spaces and in electrical or electronic communication with the thermostat device to detect environmental conditions in the rooms and/or the spaces and provide detected conditions data to the BMS application program for processing;
where the BMS application program also processes available data concerning surge timing at startup for any of the HVAC components called upon to startup.
